(19) United States
(12) Patent Application Publication
(10) Pub. No.: US 2023/0376944 A1
(43) Pub. Date: Nov. 23, 2023

(54) SMART CONTRACT DIGITAL ASSET MANAGEMENT UNIT

(71) Applicant: Flexa Inc., New York, NY (US)

(72) Inventors: Trevor Filter, New York, NY (US); Zachary Kilgore, Brooklyn, NY (US); Tyler Robert Spalding, New York, NY (US)

(73) Assignee: Flexa Inc., New York, NY (US)

(21) Appl. No.: 18/051,810

(22) Filed: Nov. 1, 2022

Related U.S. Application Data
(60) Provisional application No. 63/364,912, filed on May 18, 2022.

(51) Int. Cl. G06Q 20/38; G06Q 20/10

(52) U.S. Cl. CPC G06Q 20/3825; G06Q 20/108

(57) ABSTRACT

A computing entity of a digital asset-based interaction system includes memory and a smart contract digital asset management unit including a digital asset-based interaction interface. The digital asset-based interaction interface is associated with a digital asset-based interaction computing entity of the digital asset-based interaction system. The digital asset-based interaction interface is operable to interface with the digital asset-based interaction computing entity to execute one or more digital asset-based interactions between the computing entity and one or more other computing entities. The digital asset-based interaction interface is further operable to interface with a self-enforcing smart contract associated with the computing entity and the digital asset-based interaction computing entity to manage one or more digital assets.

### CROSS-REFERENCE TO RELATED APPLICATIONS

The present U.S. Utility Patent application claims priority pursuant to 35 U.S.C. § 119(e) to U.S. Provisional Application No. 63/364,912, entitled “SMART CONTRACT DIGITAL ASSET MANAGEMENT UNIT,” filed May 18, 2022, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to a digital asset-based interaction system and more specifically to a smart contract digital asset management unit.

### Description of Related Art

Current payment systems are vulnerable to security breaches, fraud, and identity theft. A typical payment card transaction with a merchant involves several steps (e.g., payment card authorization, clearing, and settlement) and the participation of various entities (e.g., financial institutions, payment card companies, and payment processing networks). Each step and each entity have their own varying security limitations.

The steps involved are also inconvenient, time consuming, and expensive. For example, payment card authorization (e.g., credit or debit card authorization) begins with the cardholder presenting the payment card to a merchant for goods or service. The payment card is issued by a particular financial institution (e.g., a bank) and is associated with a payment card network (e.g., Visa, Mastercard, etc.). The merchant uses a payment card machine, software, or gateway to transmit transaction data to their acquiring bank (or its processor). The acquiring bank routes the transaction data to a payment processing network and the payment processing network sends the transaction data to the cardholder's issuing bank. The issuing bank validates that the card has not been reported stolen or lost, confirms whether funds/credit is available, and sends a response code back through the payment processing network to the acquiring bank as to whether the transaction is approved.

The transaction data typically includes the payment card number, transaction amount, date, merchant's name, merchant's location, merchant category code, and an encrypted personal identification number (PIN) if entered. A response code reaches the merchant's terminal and is stored in a file until it is settled. The merchant sends the stored, approved transactions to its acquiring back (e.g., at the end of the day) and the acquiring bank reconciles and transmits approved transactions through the appropriate card-processing network. The acquiring bank deposits funds from sales into the merchant's account. The payment processing network debits the issuing bank account and credits the acquiring bank account for the amount of the transaction.

Merchants pay substantial payment card processing fees, and those costs are passed along to consumers in the form of higher prices. Most merchants pay an interchange rate on a total transaction and a flat fee to the payment card company involved (e.g., Visa, Mastercard, etc.). Rates vary based on the payment card company, the payment card type (e.g., credit, debit, business, etc.), processing type (e.g., online payment, swiped, through a mobile device, card not present, etc.), and a Merchant Category Code (MCC) that classifies a merchant's type of business. Further, merchants typically pay a commission and a flat fee to the payment processing network.

Traditional bank account-linked mobile wallet applications allow cardholders to store payment card data on a computing device via a digital wallet for more convenient transactions. For example, some mobile wallet apps use near field communication (NFC) for contactless payments (e.g., exchange of data by holding a device over a payment reader). NFC chips are specifically designed to manage financial security and only store data needed to initiate and complete a transaction. Mobile wallets use types of tokenization to assign a device account number (DAN) in place of an account or card number so that the DAN is passed to the merchant rather than the actual account/card number. As another security measure, digital wallets rely on digital certificates to verify identity. However, using a digital wallet on a device means data passes through not only the device's hardware and operating system but then also a specific payment app, and then finally the source of payment.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights. Distributed ledger technology (DLT) is a digital system that provides a consensus of replicated, shared, and synchronized digital data spread across several nodes. Unlike traditional databases, DLTs often lack central authority. The nodes of a DLT implement a consensus protocol to validate the authenticity of transactions recorded in the ledger.

Distributed ledger technology reduces the risk of fraudulent activity. For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

A cryptocurrency is a digital asset that is securely created and transferred via cryptography. Many cryptocurrencies are distributed networks based on distributed ledger technology (e.g., a blockchain). Decentralized networks like Bitcoin use pseudo-anonymous transactions that are open and public (i.e., anyone can join, create, and view transactions). To eliminate fraudulent transactions and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

A smart contract is a self-enforcing agreement embedded in computer code that can be managed by distributed ledger technology such as a blockchain. A smart contract contains a set of conditions under which the parties to the smart contract agree to interact. The code and the conditions are publicly available on the ledger. When an event outlined in the contract is triggered, the code executes. Ethereum is a blockchain built for creating smart contracts. Ethereum smart contracts execute a series of instructions written using the programming language “solidity” which works on the basis of IFTTT (IF-THIS-THEN-THAT) logic. For example, if the first set of instructions are complete, then execute the next set of instructions, and repeat until the end of the contract.

A digital asset wallet is a software program that provides a user a unique address that acts as a personal identifier pointing to the location of your digital assets and stores private keys unique to the digital asset wallet. Unlike normal wallets, digital assets do not actually store digital assets. Digital assets live on a blockchain but can be accessed using the private key associated with a digital asset wallet. Digital asset wallets include custodial digital asset wallets and non-custodial digital asset wallets. A custodial digital asset wallet is a digital wallet where a custodian (e.g., a cryptocurrency exchange) securely stores digital assets on behalf of the wallet user and manages the private keys to the wallet. Custodial digital asset wallets lessen personal responsibility but result in lack of control and require trust in the custodian. Further custodial digital asset wallets require a user to provide personal information such as a valid form of identification and banking information.

A non-custodial digital asset wallet is a digital asset wallet where the user of the digital wallet has control over the private keys of the digital wallet and does not need to provide personal information to access the digital assets. Non-custodial digital asset wallets allow for privacy, control, and freedom of access but require the user to be responsible over several aspects of the wallet (e.g., not losing the keys, etc.). Non-custodial wallets may be browser-based (e.g., software installed on a device) or hardware devices (e.g., similar to a USB storage device) among other options.

### BRIEF DESCRIPTION OF THE SEVERAL VIEWS OF THE DRAWING(S)

FIG. 1 is a schematic block diagram of an embodiment of a digital asset-based interaction system;

FIG. 2 is a flowchart of an example of a method for execution by a digital asset-based interaction computing entity of the digital asset-based interaction system;

FIG. 2A is a flowchart of another example of a method for execution by a digital asset-based interaction computing entity of the digital asset-based interaction system;

FIG. 3 is a schematic block diagram of an embodiment of a computing entity of the digital asset-based interaction system;

FIG. 4 is a schematic block diagram of another embodiment of a computing entity of the digital asset-based interaction system;

FIG. 5 is a schematic block diagram of an embodiment of a smart contract digital asset management unit;

FIG. 6 is a schematic block diagram of an embodiment of a self-enforcing smart contract blockchain;

FIG. 7 is a schematic block diagram of an example of a first computing entity attempting a double spend within the digital asset-based interaction system;

FIG. 8 is a schematic block diagram of an example of a first computing entity attempting a double spend on a non-custodial asset management unit;

FIG. 9 is a schematic block diagram of an example of a first computing entity attempting a double spend on a custodial asset management unit;

FIG. 10 is a schematic block diagram of an example of a first computing entity attempting a double spend on a smart contract digital asset management unit;

FIG. 11 is a schematic block diagram of another embodiment of a digital asset-based interaction system;

FIG. 12 is a schematic block diagram of an embodiment of an interest protocol computing entity interacting with borrower computing entities and contributor computing entities;

FIG. 13 is a schematic block diagram of an embodiment of an interest protocol computing entity interacting with a digital asset-based interaction entity and a borrower computing entity;

FIG. 14 is a schematic block diagram of an embodiment of smart contract digital asset management unit of a computing entity interacting with a digital asset backing computing entity;

FIG. 15 is a schematic block diagram of an embodiment of smart contract digital asset management unit of a computing entity interacting with a digital asset backing computing entity;

FIG. 16 is a flowchart of an example of a method of generating interest on digital assets of a digital asset-based interaction system;

FIG. 17 is a schematic block diagram of an embodiment of a digital asset-based interaction system;

FIGS. 18A-18B are schematic block diagrams of examples of staking entities of a digital asset-based interaction system;

FIG. 19 is a schematic block diagram of an embodiment of a staking computing entity interacting with a digital asset backing computing entity; and

FIG. 20 is a flowchart of an example of a method of borrowing system digital assets to back digital asset-based interactions of a digital asset-based interaction system.

### DETAILED DESCRIPTION OF THE INVENTION

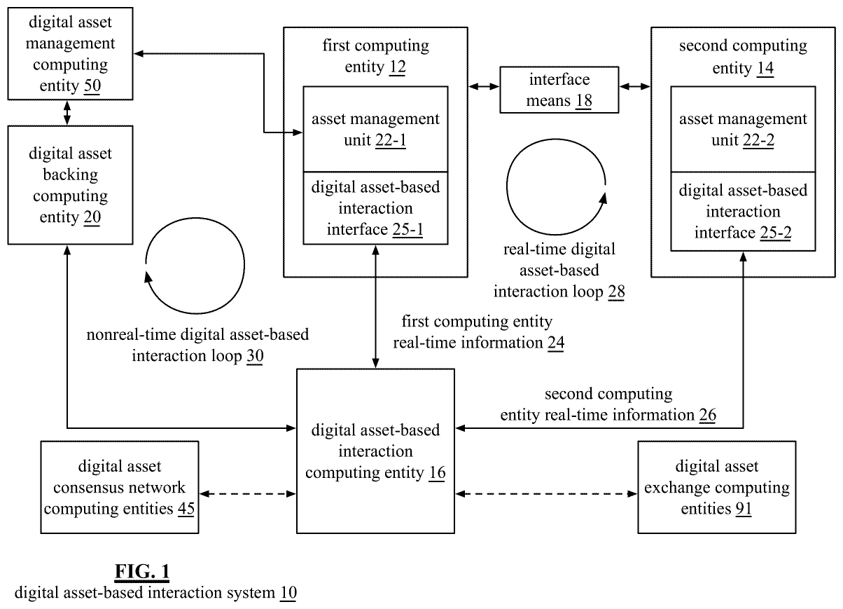

FIG. 1 is a schematic block diagram of an embodiment of a digital asset-based interaction system 10 that includes a first computing entity 12, a second computing entity 14, a digital asset-based interaction computing entity 16, an interface means 18, a digital asset backing computing entity 20, a digital asset management computing entity 50, one or more digital asset exchange computing entities 91, and one or more digital asset consensus network computing entities 45. The digital asset-based interaction system 10 facilitates a digital asset-based interaction (e.g., a digital asset-based payment) between the first computing entity 12 and the second computing entity 14 where the first computing entity 12 provides a digital asset (e.g., cryptocurrency) and the second computing entity 14 (e.g., a merchant) accepts assets in a desired asset format (e.g., fiat currency, a specific digital asset) and overcomes the following issues.

At the filing of this application, digital assets such as cryptocurrency are not widely accepted by merchants as a form of payment for a variety of reasons. For one, many merchants do not want to hold cryptocurrency. Holding cryptocurrency involves several issues merchants are unfamiliar with and/or unequipped to deal with. These issues include holding private key information, legal compliance, government regulation, timing issues such as waiting for transaction confirmations, etc. Accepting digital assets such as cryptocurrency presents operational security issues and includes a level of technical complexity outside the scope of general merchant capabilities. Additionally, the value of cryptocurrency can be volatile, sometimes fluctuating dramatically in the course of one day. As another reason, merchants are reluctant to invest in expensive point-of-sale upgrades to accommodate cryptocurrency payments directly. As yet another reason, many cryptocurrency payments are public and expose sensitive merchant/customer information.

While some digital wallet applications enable retail blockchain payments, they are universally dependent on existing payment networks and thus are susceptible to the fraud attacks of the existing payment networks. For example, a cryptocurrency is linked to a payment card (e.g., a credit card, debit card, gift card, etc.), where a cryptocurrency payment is converted and conducted as a payment card transaction and, thus susceptible to the same fraud attacks as the payment card. Further, a billing address and/or other personal customer information may be required for a merchant to verify traditional payment card payments. A merchant may store this information which consumes data storage space and renders additional private customer information vulnerable to theft and fraud. Additionally, the costs of the existing payment network (e.g., payment transaction costs, fees, etc.) are maintained. Adding a digital asset payment option within an existing payment network only increases those costs.

Even though digital asset payments such as cryptocurrency payments significantly reduce fraudulent activity as compared to traditional payment systems, fraudulent digital asset transactions are possible. For example, malicious users can manipulate a cryptocurrency blockchain to “double spend” (e.g., create one transaction within a block to transfer an amount to a merchant and create another block without that transaction such that the transfer to the merchant does not exist). As another example, malicious or faulty digital wallet software can prevent a digital asset transaction from being authorized and completed correctly.

As used herein, a computing entity may be one or more computing devices, one or more distributed computing devices, and/or one or more modules executing on one or more computing devices. Within the digital asset-based interaction system 10, the first computing entity 12, the second computing entity 14, the digital asset-based interaction computing entity 16, the digital asset backing computing entity 20, the digital asset management computing entity 50, the one or more digital asset exchange computing entities 91, and the one or more digital asset consensus network computing entities 45 may be one or more computing devices, one or more distributed computing devices, and/or one or more modules executing on one or more computing devices.

As used herein, a computing device may be one or more portable computing devices and/or one or more fixed computing devices. The first computing entity 12, the second computing entity 14, the digital asset-based interaction computing entity 16, the digital asset backing computing entity 20, the digital asset management computing entity 50, the one or more digital asset exchange computing entities 91, and the one or more digital asset consensus network computing entities 45 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The digital asset-based interaction computing entity 16 is operable to connect to the one or more digital asset exchange computing entities 91 to convert an asset in a first asset format (e.g., a digital asset, fiat currency) to an asset in a second asset format (e.g., fiat currency, another digital asset, etc.), back digital-asset based interactions via the digital asset backing computing entity 20 such that digital asset-based interactions can be authorized and/or completed successfully in real-time, and connect to the one or more digital asset consensus network computing entities 45 to verify receipt of digital assets (e.g., a consensus network that implements a verification method associated with a particular digital asset). Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights.

The one or more digital asset exchange computing entities 91 are online platforms that allow users to trade digital assets for other forms of digital assets or other assets such as conventional government-issued fiat currency and/or other digital currencies. In an embodiment, the digital asset-based interaction computing entity 16 is a digital asset exchange computing entity where the digital asset exchange computing entity 16 may be specially licensed for exchange when licensing is required. In another embodiment, the digital asset-based interaction computing entity 16 and/or the one or more digital asset exchange computing entities 91 may be associated with one or more digital asset holding companies. A digital asset holding company stores sensitive materials and has insurance policies to protect against theft and fraud. A digital asset holding company may be specially licensed for holding digital assets when licensing is required.

The digital asset-based interaction computing entity 16 may be associated with a stored value account (SVA) device where the SVA device is associated with the second computing entity 14 (e.g., a second computing entity has an SVA account with the SVA device) such that an SVA is generated for payment. In another embodiment, the digital asset-based interaction computing entity 16 is operable to generate stored value accounts (SVAs). Generation of SVAs for transactions is described in co-pending patent application Ser. No. 16/376,911, entitled, “SECURE AND TRUSTED DATA COMMUNICATION SYSTEM,” filed Apr. 5, 2019.

Each of the first and second computing entities 12 and 14 include an asset management unit 22-1 and 22-2 respectively. The asset management units 22-1 and/or 22-2 may be digital wallet applications or network enabled smart contract applications (e.g., smart contract digital asset management units) installed on or otherwise usable by the first and second computing entities 12 and 14 that function to facilitate the storage and management (e.g., buy, sell, trade, custody, etc.) of digital assets. Alternatively, an asset management unit may be an application that facilitates receiving assets during an interaction such as POS software and/or hardware that may or may not include a digital wallet function depending on the types of assets a computing entity wishes to accept and the desired method of receiving those assets.

The asset management units 22-1 and/or 22-2 may be custodial digital wallet applications associated with a digital asset management computing entity 50 that may be specially licensed and insured to hold digital assets (e.g., a digital asset holding and management company, a cryptocurrency holding company, a cryptocurrency holding and exchange company, etc.). Alternatively, the asset management units 22-1 and/or 22-2 may be non-custodial digital wallet applications associated with a non-custodial digital asset management computing entity 50 (e.g., a digital asset exchange company) where the asset management units 22-1 and/or 22-2 store digital assets and the first and second computing entities 12-14 manage private keys to the asset management units 22-1 and/or 22-2.

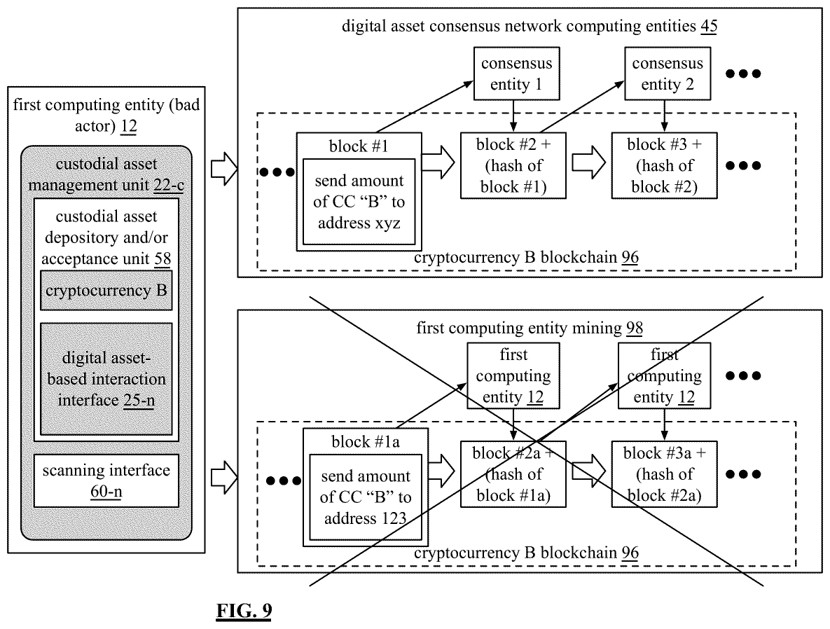

Alternatively, the asset management units 22-1 and/or 22-2 may be custodial or non-custodial digital wallet applications associated with the digital asset-based interaction computing entity 16 (e.g., where the digital asset-based interaction computing entity 16 is a digital asset management computing entity 50). Alternatively, the asset management units 22-1 and/or 22-2 are network enabled smart contract applications (e.g., smart contract digital asset management units). A network enabled smart contract application allows a user to upload digital assets to a network enabled smart contract using a private key (e.g., non-custodial) and eliminates double spending issues associated with non-custodial wallets. Double spending issues associated with non-custodial wallets will be discussed in more detail with reference to FIG. 8.

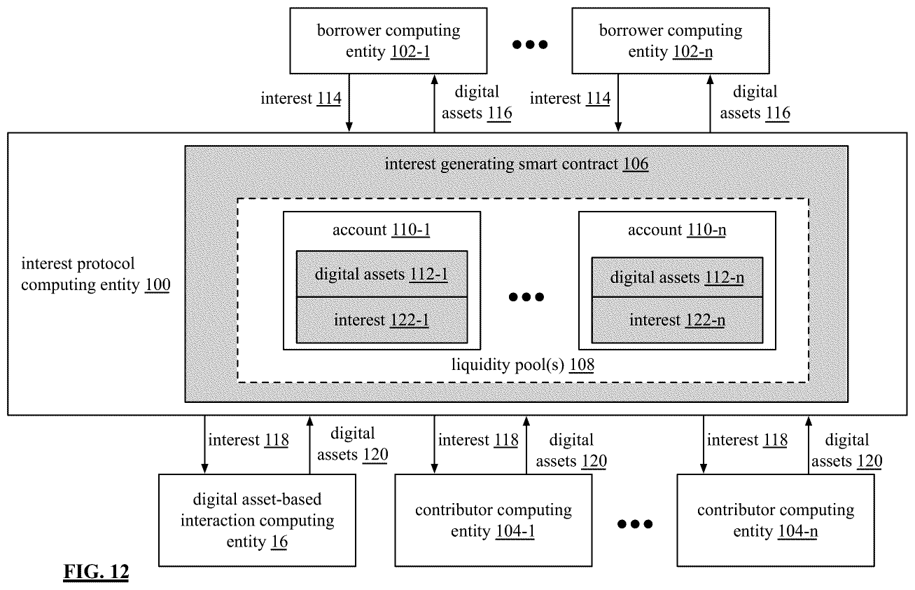

Network enabled smart contract applications further allow the digital asset-based interaction computing entity 16 to earn interest from digital assets stored by network enabled smart contract applications. The interest can be distributed as rewards and/or used to cover transaction fees to potentially allow merchant transaction fee-free digital asset-based interactions. Interest earnings and distributions will be discussed in more detail with reference to FIGS. 11-16.

The digital asset backing computing entity 20 may be a part of or separate from the digital asset-based interaction computing entity 16. The digital asset backing computing entity 20 stores (or otherwise has access to) system digital assets (e.g., system cryptocurrency, system tokens, etc.) as collateral to back digital asset-based interactions of the digital asset-based interaction system 10. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency.

The digital asset backing computing entity 20 is associated with the first computing entity 12, the second computing entity 14, and/or a type of digital asset. As an example, the digital asset backing computing entity 20 is associated with the asset management unit 22-1 of the first computing entity 12.

The digital asset management computing entity 50 is associated with the digital asset backing computing entity 20 via one or more accounts and is operable to deposit system digital assets into the one or more accounts to back digital asset-based interactions of users of an associated asset management unit (e.g., asset management unit 22-1). The digital asset management computing entity 50 is incentivized to back asset management unit interactions by receiving rewards from the digital asset backing computing entity 20 such as a percentage of system digital asset back on successful transactions. Additionally, the system digital asset provides payment utility such as lower foreign exchange rates.

The digital asset management computing entity 50 is also referred to as a staking entity and in this example, is associated with a developer of the asset management unit (e.g., a digital wallet developer). Because the digital asset management computing entity 50 is backing the asset management unit interactions and is rewarded by successful transactions, the digital asset management computing entity 50 is incentivized to produce a quality asset management unit that prevents user fraud and to remedy faulty software that affects transaction success. In another embodiment, the asset management units 22 may be backed by a different and/or additional type(s) of staking entities such as one or more user computing devices, one or more merchant computing entities, one or more computing entities associated with a corporation and/or business, etc.

In another embodiment, a staking entity is operable to use any type of digital asset to back asset management unit interactions. The staking entity provides a desired type of digital asset to the digital asset backing computing entity 20 as collateral to borrow system digital assets. For example, the staking entity deposits an amount of a type of digital asset into a network enabled smart contract in which the terms of the network enabled smart contract will trigger sending the amount of a type of digital asset to the digital asset backing computing entity 20 upon certain events.

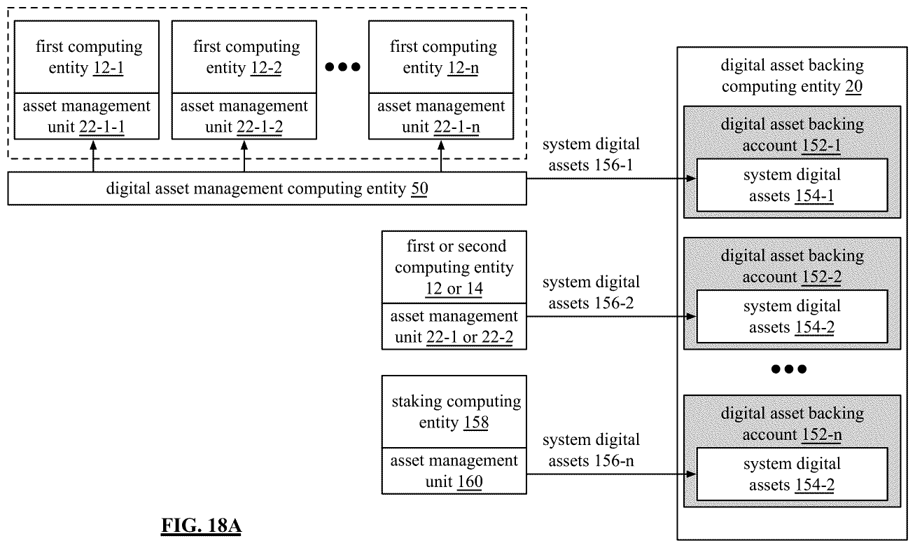

As another example, the staking entity transfers the amount of a type of digital asset to the digital asset backing computing entity 20, where the digital asset backing computing entity 20 will send it back to the staking entity upon certain events. Upon providing the amount of a type of digital asset, the staking entity may borrow a substantially equivalent amount of system digital assets to back digital asset-based interactions associated with the staking entity. Using a desired digital asset to back asset management unit interactions will be discussed in greater detail with reference to FIGS. 17-20.

When a computing entity functions to primarily receive assets (e.g., the computing entity is a merchant computing device; also referred to herein as a receiving computing entity), an asset management unit (e.g., asset management unit 22-2) is not necessarily associated with a digital asset management computing entity 50 if there is no need back digital assets (e.g., assets are received and not sent). For example, when the second computing entity 14 is a merchant computing entity, the asset management unit 22-2 may be merchant POS software enabled for use in the digital asset-based interaction system 10.

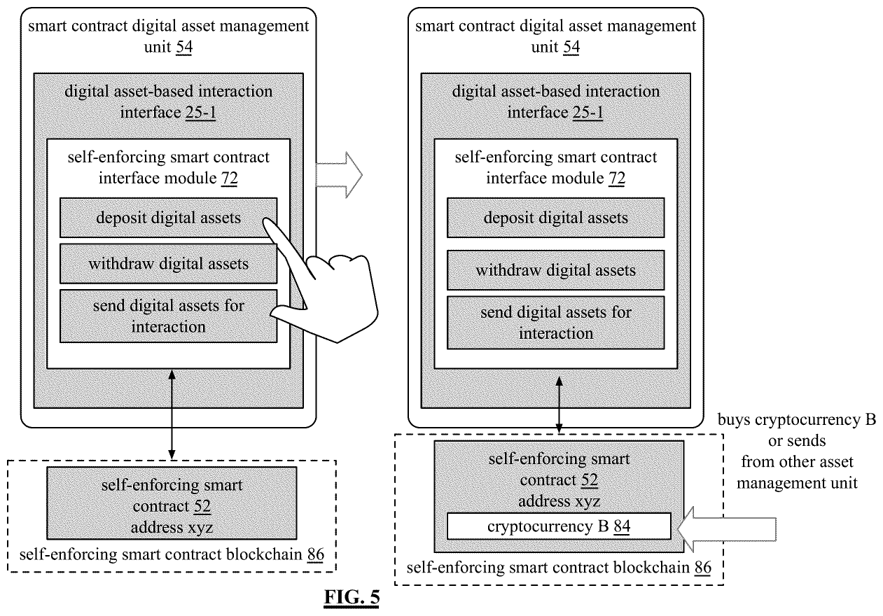

The asset management units 22-1 and 22-2 include digital asset-based interaction interfaces 25-1 and 25-2 operable to interface with the digital asset-based interaction computing entity 16. The digital asset-based interaction interfaces 25-1 and 25-2 are digital asset-based interaction computing entity application programming interfaces (APIs) integrated into asset management units 22-1 and 22-2 that allow the first and second computing entities 12 and 14 to connect to the digital asset-based interaction computing entity 16 for digital asset-based interactions. The digital asset-based interaction interfaces 25-1 and 25-2 facilitate digital asset-based interaction system 10 interactions and will be discussed in greater detail with reference to FIG. 4.

A digital asset-based interaction interface may be included in an asset management unit when the digital asset management computing entity 50 deposits system digital assets to back interactions made by the asset management unit or in an asset management unit that primarily receives assets (e.g., a merchant) via the digital asset-based interaction system 10. The first and second computing entities 12 and 14 are operable to establish an account with the digital asset-based interaction computing entity 16 to use the digital asset-based interaction interfaces 25-1 and 25-2. The first and second computing entities 12 and 14 are operable to access features of the digital asset-based interaction computing entity 16 via the digital asset-based interaction interfaces 25-1 and 25-2 (e.g., via a direct link or by signing in for temporary use).

The second computing entity 14 may be associated with a particular merchant that facilitates payments from the first computing entity 12 to the merchant. For example, the second computing entity may be a fixed POS computing device, a merchant e-commerce website, a merchant mobile application (“app”), etc. The second computing entity 14 may include payment features tailored to the type of second computing entity 14 involved in a payment. For example, when the second computing entity 14 is a fixed POS computing device (e.g., a register), the second computing entity includes features for in-person payment interaction (e.g., a scanning device, a touchscreen, a receipt printer, etc.).

As another example, when the second computing entity 14 is an e-commerce website or merchant mobile application (“app”) the second computing entity may include a variety of existing payment processing features (e.g., existing hardware and/or software) for processing online payments within existing payment networks (e.g., an Secure Socket Layers (SSL) certificate, e-commerce shopping cart software, order and product management features, customer profile management capabilities, a payment gateway, an e-commerce merchant account with a processing bank to accept credit and debit card payments, etc.).

The first computing entity 12 and the second computing entity 14 interact via the interface means 18. The interface means 18 is one or more of: a direct link and a network connection. The direct link includes one or more of: a scanning device (e.g., video, camera, infrared (IR), barcode scanner, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network and a WAN is the Internet, cellular telephone infrastructure, and/or satellite communication infrastructure.

As an example, the first computing entity 12 is a smart phone, the second computing entity 14 is a fixed merchant POS device (e.g., a POS register) and the interface means 18 is the fixed merchant POS device's scanning device (e.g., camera, barcode scanner, etc.). As another example, the first computing entity 12 is a smart phone, the second computing entity 14 is a fixed merchant POS device (e.g., a POS register) and the interface means 18 is the smart phone's scanning device (e.g., a front or back camera).

As another example, the first computing entity 12 is a smart phone, the second computing entity 14 is an online POS connection device (e.g., an e-commerce website or e-commerce mobile app) and the interface means 18 is a network connection. For example, a smart phone uses an internet browser application (via cellular or wireless internet connection) to access a merchant's e-commerce website. As another example, a smart phone uses a network connection to connect to an installed merchant e-commerce mobile app.

As yet another example, a combination of interface means 18 is possible. For example, the first computing entity 12 is a smart phone and the second computing entity 14 is an online POS connection device (e.g., an e-commerce website). The e-commerce website is accessed via a network connection interface means 18 on a computing device associated with the user of the first computing entity 12 (e.g., a laptop or desktop computer). The computing device displays information for use by the first computing entity's scanning device (e.g., front or back camera).

In an example of operation, the first computing entity 12 and the second computing entity 14 interact via the interface means 18 to initiate a digital asset-based interaction (also referred to herein as “interaction”). A digital asset-based interaction involves sending digital asset-based value from the first computing entity to the second computing entity (e.g., a loan from the first computing entity to the second computing entity, a payment from the first computing entity to the second computing entity, a gift from the first computing entity to the second computing entity, etc.) where the second computing entity 14 accepts assets in a desired asset format (e.g., fiat currency or a desired digital asset that may differ from the digital asset the first computing entity 12 wishes to use in the interaction) and the first computing entity 12 provides a digital asset.

To initiate the interaction, the first computing entity 12 may display a unique scannable code to the second computing entity 14 when the interface means 18 is the second computing entity 14 scanning device. As another example, the first computing entity 12 may display and/or share an authorization key code when a code display interaction mode is disabled. As another example, the second computing entity 14 displays a unique scannable code for the first computing entity 12 when the interface means 18 is the first computing entity 12 scanning device. As another example, the second computing entity 14 may display and/or share an authorization key charge code when a code scan interaction mode is disabled. As another example, the first computing entity 12 connects to the second computing entity 14 via a network connection interface means 18 to initiate an interaction (e.g., when the second computing entity 14 is an e-commerce website).

During the interaction initiation, the first computing entity 12 sends first computing entity real-time information 24 to the digital asset-based interaction computing entity 16 via the digital asset-based interaction interface 25-1 and/or the second computing entity 14 sends second computing entity real-time information 26 to the digital asset-based interaction computing entity 16 via its digital asset-based interaction interface 25-2 (e.g., from requesting a scannable code, from scanning a scannable code, from receiving an authorization key code, from an e-commerce website checkout option selection, etc.).

The first computing entity real-time information 24 includes at least an identifier (e.g., a user ID) and an indication of a type of digital asset the user of the first computing entity wishes to use in a digital asset-based interaction with the second computing entity 14. The second computing entity real-time information 26 includes at least an identifier (e.g., a user ID, a merchant ID, etc.) and an indication of a desired asset format (e.g., a fiat currency, a cryptocurrency, etc.) for receiving assets in the digital asset-based interaction. One or more of the first computing entity real-time information 24 and the second computing entity real-time information 26 includes the amount involved in the digital asset-based interaction. The first computing entity real-time information 24 and the second computing entity real-time information 26 may include further information and/or metadata such as loyalty information, personal information (address, name, etc.), shipping details, bill splitting information, a request for additional information, etc.

When the digital asset-based interaction computing entity 16 receives the first and second computing entity real-time information, the digital asset-based interaction computing entity 16 initiates: 1) a real-time digital asset-based interaction process (e.g., the real-time digital asset-based interaction loop 28) and 2) a nonreal-time digital asset-based interaction process to reconcile the digital asset-based interaction with the digital asset backing computing entity 20 (e.g., the nonreal-time digital asset-based interaction loop 30). The reconciliation of the digital asset-based interaction with the digital asset backing computing entity 20 occurs within a time frame that is longer than the time frame of the real-time digital asset-based interaction. For example, the reconciliation of the digital asset-based interaction with the digital asset backing computing entity 20 occurs over the course of minutes whereas the time frame of the real-time digital asset-based interaction takes a few seconds.

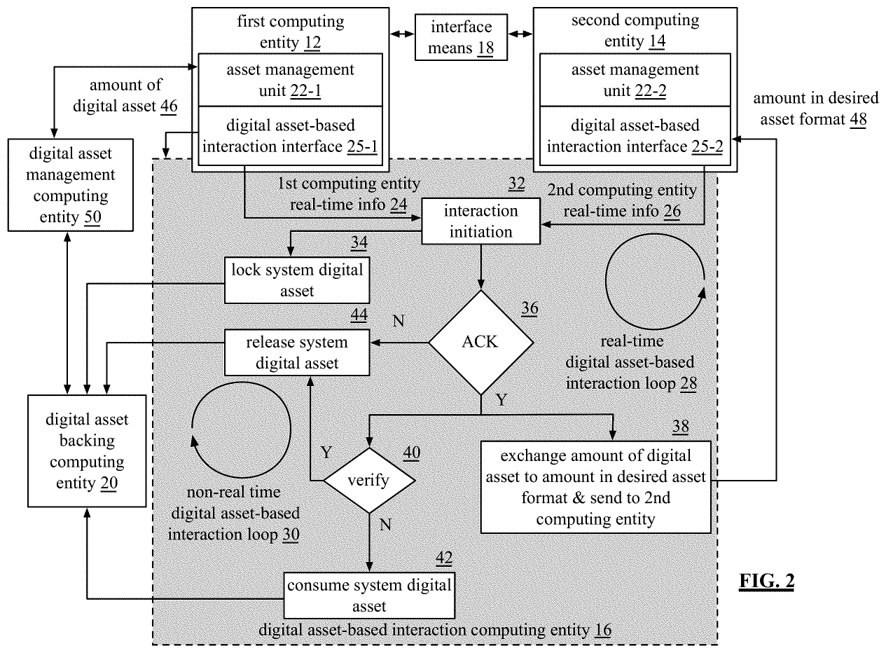

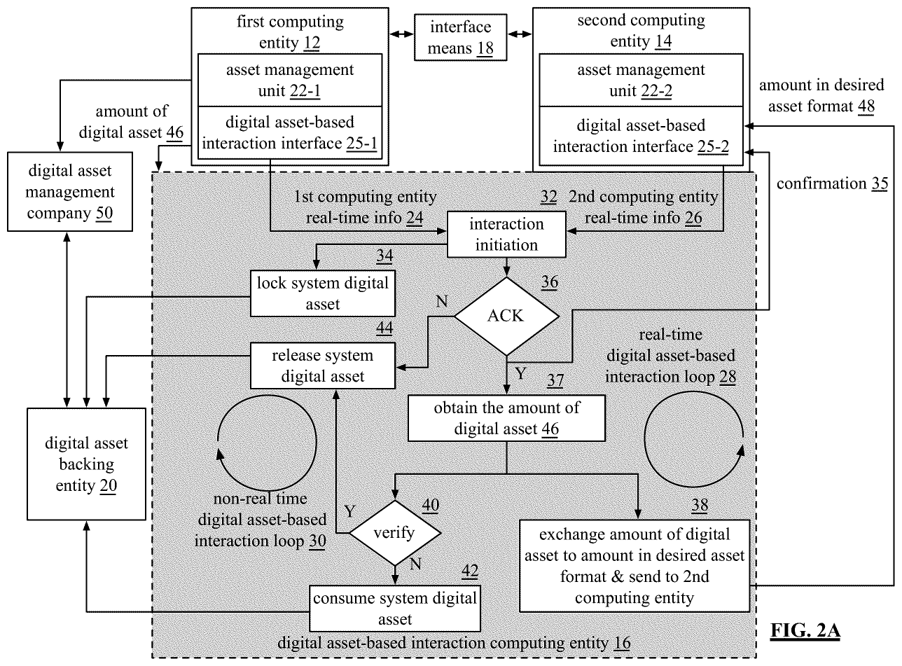

Within the nonreal-time digital asset-based interaction loop 30, when at least the first computing entity real-time information is received, the digital asset-based interaction computing entity 16 instructs the digital asset backing computing entity 20 to lock an amount of system digital asset associated with the digital asset-based interaction. When the digital asset-based interaction computing entity 16 locks the system digital asset, a rate quote for the amount of digital asset used by the first computing entity 12 is locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange. Locking a rate quote is discussed in more detail with reference to FIG. 2A.

Within the real-time digital asset-based interaction loop 28, when the digital asset-based interaction computing entity 16 receives an amount of digital asset from the first computing entity 12 to use in the digital asset-based interaction, a network acknowledgment (ACK) of the receipt of the amount of the digital asset is generated.

In an alternative embodiment, the ACK is generated after the system digital asset is locked and prior to receiving the amount of the digital asset from the first computing entity 12. For example, locking the system digital asset implies authorization of the interaction and the digital asset-based interaction computing entity 16 allows a time period (e.g., up to five minutes) prior to pulling digital assets from the first computing entity 12 (e.g., the first computing entity has time to add tip, split payment with another user, adjust type of digital asset used, etc.). The second computing entity 14 is provided a confirmation of this ACK. For example, when the second computing entity 14 is a POS computing device such as an attended register, this ACK may successfully end the in-person transaction such that a merchant and customer can part ways. However, the second computing entity 14 receives the payment up to a few minutes later. This embodiment is discussed in more detail with reference to FIG. 2A.

If the interaction initiation is terminated (e.g., interaction initiation fails and/or is cancelled by the first and/or the second computing entity) within a certain amount of time prior to the digital asset-based interaction computing entity 16 continuing with the following steps of the real-time digital asset-based interaction loop 28 (e.g., exchanging the digital asset to the desired asset format and sending the amount in the desired asset format to the second computing entity), the ACK is not generated, and the digital asset-based interaction is terminated. Within the nonreal-time digital asset-based interaction loop 30, when the ACK is not generated, the digital asset-based interaction computing entity 16 instructs the digital asset backing computing entity 20 to release the amount of locked system digital asset.

When the digital asset is managed by a distributed ledger technology (e.g., is a cryptocurrency), sending the amount of digital asset to the digital asset-based interaction computing entity 16 is a transaction added to the digital asset blockchain of the digital asset used by the first computing entity 12 (e.g., this information is published). However, other details related to the interaction (e.g., the identity of the second computing entity 14, transaction fees owed by the second computing entity 14, etc.) are managed privately by the digital asset-based interaction computing entity 16 off-chain. Therefore, the digital asset-based interaction system 10 keeps confidential second computing entity 14 related information (e.g., revenue, consumer spending behavior, etc.) and confidential first computing entity 12 related information (e.g., consumer identity of purchases, amount spent at a particular merchant, payees/merchants frequented, etc.) private (i.e., not published on a blockchain for anyone to see).

Continuing with the real-time digital asset-based interaction loop 28, when the ACK is generated and receipt of the amount of digital asset is received, the digital asset-based interaction computing entity 16 connects to the one or more digital asset exchange entities 91 to exchange the amount of the digital asset received from the first computing entity 12 to an amount in the desired asset format. Digital asset exchange is done quickly (e.g., 30 seconds to a few minutes) to account for exchange rate volatility. The exchange can also be performed immediately on a credit-based account to eliminate any pricing volatility. The digital asset-based interaction computing entity 16 sends the amount in the desired asset format to the second computing entity 14 to complete the real-time portion of the digital asset-based interaction.

Continuing with the nonreal-time digital asset-based interaction loop 30, the digital asset-based interaction computing entity 16 verifies the amount of the digital asset received from the first computing entity 12. For example, the digital asset-based interaction computing entity 16 connects to the one or more digital asset consensus network computing entities 45 (“consensus network”) that verify the amount of the digital asset received from the first computing entity 12. The consensus network implements a verification process that may take minutes to hours of time.

For example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the first computing entity 12 is using Bitcoin, the digital asset-based interaction computing entity 16 seeks a desired number of confirmations of the amount of the cryptocurrency received by the first computing entity 12 from the consensus network 16 (e.g., via Bitcoin miners). The transaction may not be verified by the digital asset-based interaction computing entity 16 for an hour or more. As such, the nonreal-time digital asset-based interaction loop 30 takes longer than the real-time digital asset-based interaction loop 28.

When the digital asset-based interaction computing entity 16 verifies the amount of the digital asset received by the first computing entity 12, the digital asset-based interaction computing entity 16 instructs the digital asset backing computing entity 20 to release the amount of system digital asset associated with the real-time digital asset interaction. When the digital asset-based interaction computing entity 16 does not verify the amount of the digital asset received by the first computing entity 12, the digital asset-based interaction computing entity 16 instructs the digital asset backing computing entity 20 to consume the amount of system digital asset associated with the real-time digital asset interaction. If the system digital asset is borrowed, the digital asset-based interaction computing entity 16 consumes the amount of collateral digital assets used to borrow the system assets.

For example, if fraudulent activity occurs (e.g., the first computing entity acts maliciously to spend at two merchants simultaneously, software of the asset management unit 22-1 is corrupted, etc.) the digital asset-based interaction computing entity 16 consumes the amount of system digital asset associated with the real-time digital asset interaction. As a specific example, if the first computing entity 12 attempts to double spend a transaction, the verification (e.g., the desired number of confirmations in a Bitcoin blockchain example) will not be received and the digital asset-based interaction computing entity 16 will not be able to verify the amount of the digital asset received by the first computing entity 12.

If the verification is not received, the digital asset-based interaction computing entity 16 consumes (e.g., withdraws) the amount of system digital asset locked by the digital asset backing computing entity 20 to cover the real-time digital asset interaction that occurred with the second computing entity 14. Consuming the amount of system digital asset means that the amount of system digital asset (or digital assets used to borrow system digital assets) is transferred (e.g., via an on-chain transaction) from an address associated with the digital asset management computing entity 50 to an address associated with the digital asset-based interaction computing entity 16.

FIG. 2 is a flowchart of an example of a method for execution by a digital asset-based interaction computing entity 16 of the digital asset-based interaction system 10 of FIG. 1. FIG. 2 includes a first computing entity 12, a second computing entity 14, a digital asset-based interaction computing entity 16, an interface means 18, a digital asset backing computing entity 20, and a digital asset management computing entity 50. The first and second computing entities 12 and 14 include asset management units 22-1 and 22-2 respectively that interface with the digital asset-based interaction computing entity 16 to facilitate digital asset-based interactions and operate as discussed with reference to FIG. 1.

The second computing entity 14 may be a merchant computing entity that is operable to process payments from a computing entity and includes features tailored to the type of second computing entity 14 it is (e.g., a scanning device, a touchscreen, mobile payment features, online payment features, etc.).

The digital asset management computing entity 50 is associated with the digital asset backing computing entity 20 via an account and is operable to deposit system digital assets into its account to back digital asset-based interactions made by users of its associated asset management unit (e.g., asset management unit 22-1). The first computing entity 12 and the second computing entity 14 interact via the interface means 18 as discussed with reference to FIG. 1. For example, the interface means 18 is a scanning device of the first computing entity 12 and/or the second computing entity 14.

The method begins with step 32 where an interaction is initiated. An interaction is any activity involving sending digital asset-based value from the first computing entity to the second computing entity (e.g., a loan from the first computing entity to the second computing entity, a payment from the first computing entity to the second computing entity, a gift from the first computing entity to the second computing entity, etc.) where the second computing entity 14 accepts assets in a desired asset format (e.g., fiat currency or a desired digital asset that differs from the digital asset the first computing entity 12 wishes to use in the interaction) and the first computing entity provides a digital asset. An interaction is initiated when the first and second computing entities interact via the interface means 18 as discussed with reference to FIG. 1.

During the interaction initiation, the digital asset-based interaction computing entity 16 receives first computing entity real-time information 24 and second computing entity real-time information 26 regarding the digital asset-based interaction between the first computing entity 12 sending digital assets and the second computing entity 14 accepting assets in a desired asset format.

For example, the first computing entity 12 sends first computing entity real-time information 24 to the digital asset-based interaction computing entity 16 via the digital asset-based interaction interface 25-1 of the asset management unit 22 and the second computing entity 14 sends second computing entity real-time information 26 to the digital asset-based interaction computing entity 16 via the digital asset-based interaction interface 25-2 (e.g., from either requesting or scanning a scannable code). As another example, the digital asset-based interaction interface of the first computing entity 12 or the second computing entity 14 may send the first and second computing entity real-time information 24 and 26 to the digital asset-based interaction computing entity 16 (e.g., the first computing entity 12 sends the second computing entity and the first computing entity real-time information 24 and 26).

The first computing entity real-time information 24 includes an identifier (e.g., a user ID) and a type of digital asset (e.g., a cryptocurrency) it wishes to use in a real-time digital asset based interaction with the second computing entity 14. The second computing entity real-time information 26 includes an identifier (e.g., a merchant ID) and a type of desired/selected asset format (e.g., a fiat currency, another cryptocurrency) for receiving value from the first computing entity 12. One or more of the first computing entity real-time information 24 and the second computing entity real-time information 26 includes the amount of the real-time digital asset-based interaction. The first computing entity real-time information 24 and the second computing entity real-time information 26 may include further information and/or metadata such as loyalty information, personal information (address, name, etc.), shipping details, bill splitting information, a request for additional information, etc.

When the digital asset-based interaction computing entity 16 receives the real-time information 24-26, the digital asset-based interaction computing entity 16 initiates 1) a real-time digital asset-based interaction process (e.g., the real-time digital asset-based interaction loop 28) and 2) a nonreal-time digital asset-based interaction process to reconcile the digital asset-based interaction with the digital asset backing computing entity 20 (e.g., the nonreal-time digital asset-based interaction loop 30). The reconciliation of the digital asset-based interaction with the digital asset backing computing entity 20 occurs within a time frame that is longer than the time frame of the real-time digital asset-based interaction.

The method continues with step 34 where, within the nonreal-time digital asset-based interaction loop 30, the digital asset-based interaction computing entity 16 instructs the digital asset backing computing entity 20 to lock an amount of system digital asset associated with the digital asset-based interaction. The amount of system digital asset locked may be based on one or more of an amount involved in the interaction, a type of interaction, a type of item involved in the interaction, the first computing entity 12 (e.g., a typical amount the first computing entity 12 spends, an account balance, etc.), and the second computing entity 14 (e.g., the type of merchant the second computing entity 14 is associated with, a type of goods the merchant sells, a default amount set by the merchant, etc.).

When the digital asset-based interaction computing entity 16 locks the system digital asset, a rate quote for the amount of digital asset used by the first computing entity 12 may be locked as discussed with reference to FIG. 1. The method continues with step 36 where a network acknowledgment (ACK) of the receipt of the amount of the digital asset is or is not generated. For example, when the digital asset-based interaction computing entity 16 receives an amount of digital asset 46 from the first computing entity 12 to use in the real-time digital asset-based interaction, the ACK is generated and the method continues to steps 38 and 40. If the interaction initiation is terminated (e.g., interaction initiation fails and/or is cancelled by the first and/or the second computing entity) within a certain amount of time prior to the digital asset-based interaction computing entity 16 continuing with the following steps of the real-time digital asset-based interaction loop 28, the ACK is not generated, and the digital asset-based interaction terminates. Within the nonreal-time digital asset-based interaction loop 30, when the ACK is not generated, the method continues with step 44 where the digital asset-based interaction computing entity 16 instructs the digital asset backing computing entity 20 to release the amount of locked system digital asset.

Within the real-time digital asset-based interaction loop 28, when the ACK is generated, the method continues with step 38 where the digital asset-based interaction computing entity 16 exchanges (or connects to a digital asset exchange to exchange) the amount of the digital asset 46 received from the first computing entity 12 to an amount of assets in a desired asset format (e.g., fiat currency, a particular digital asset, etc.). Digital asset exchange is done quickly (e.g., 30 seconds to a few minutes) to account for exchange rate volatility. The digital asset-based interaction computing entity 16 sends the amount in the desired asset format 48 to the second computing entity 14 to complete the real-time digital asset-based interaction.

Within the nonreal-time digital asset-based interaction loop 30, when the ACK is generated at step 36, the method continues with step 40 where the digital asset-based interaction computing entity 16 verifies the amount of the digital asset 46 received from the first computing entity 12. For example, when the digital asset is cryptocurrency, the digital asset-based interaction computing entity 16 connects to a consensus network that verifies the amount of the cryptocurrency received from the first computing entity 12. The consensus network implements a verification process that may take minutes to hours of time. Other digital asset verification processes are possible and are based on the type of digital asset involved.

When the digital asset-based interaction computing entity 16 verifies the amount of the digital asset received by the first computing entity 12 at step 40, the method continues to step 44 where the digital asset-based interaction computing entity 16 instructs the digital asset backing computing entity 20 to release the amount of system digital asset locked for the digital asset-based interaction. When the digital asset-based interaction computing entity 16 does not verify the amount of the digital asset received by the first computing entity 12 at step 40, the method continues to step 42 where the digital asset-based interaction computing entity 16 instructs the digital asset backing computing entity 20 to consume the amount of system digital asset locked for the digital asset-based interaction. Consuming the amount of system digital asset means that the digital asset backing computing entity 20 transfers the amount of system digital asset to an address controlled by the digital asset-based interaction computing entity 16 in order to cover the amount of the real-time digital asset-based interaction.

FIG. 2A is a flowchart of an example of a method for execution by a digital asset-based interaction computing entity 16 of the digital asset-based interaction system 10 of FIG. 1. FIG. 2A is similar to the method of FIG. 2 except that the ACK at step 36 is generated after the system digital asset is locked but prior to receiving the amount of the digital asset from the first computing entity 12. Locking the system digital asset implies authorization of the interaction and the digital asset-based interaction computing entity 16 allows a time period (e.g., up to five minutes) prior to obtaining digital assets from the first computing entity 12 (e.g., the first computing entity has time to add tip, split the payment with another user, adjust type of digital asset used, etc.). The second computing entity 14 is provided a confirmation of this ACK. For example, when the second computing entity 14 is a POS computing device such as an attended register, this ACK may successfully end the in-person transaction such that the merchant and customer can part ways. However, the second computing entity 14 receives payment up to a few minutes after the in-person transaction.

When the digital asset-based interaction computing entity 16 locks the system digital asset, a rate quote for the amount of digital asset used by the first computing entity 12 is locked. The digital asset-based interaction computing entity 16 locks the rate quote based on a tolerance window acceptable to the user of the first computing entity 12. For example, the rate quote may be higher than a current rate quote if the window of time provided to receive funds is longer. The digital asset-based interaction computing entity 16 has knowledge of the fluctuations on the digital asset exchange used and is operable to adjust the rate quotes according to a digital asset's availability on the exchange. Further, once a user authorizes a digital asset-based interaction, the digital asset indicated in the interaction may be exchanged by the digital asset-based interaction computing entity 16 on credit (even if it has not been received yet) with the exchange to ensure a particular rate quote. Once the digital asset is received from the user, the accounting is balanced within the digital asset-based interaction computing entity 16.

As another example, the digital asset-based interaction computing entity 16 may utilize a smart contract based decentralized pool with a reserve of one or more smart contract compatible digital assets (e.g., Ethereum Request for Comment (“ERC20”) tokens) for real-time digital asset exchanges to ensure a particular rate quote. For example, the digital asset-based interaction computing entity 16 exchanges smart contract compatible digital assets from the reserve (e.g., a substantial equivalent to the amount of digital asset used in the real-time digital asset-based interaction) for a substantially equivalent amount of assets in a desired asset format. When the amount of digital asset is received by the digital asset-based interaction computing entity 16, the digital asset-based interaction computing entity 16 is operable to exchange the amount of digital asset to the substantially equivalent amount of the smart contract compatible token used to cover the real-time digital asset exchange.

When the ACK is generated, the digital asset-based interaction computing entity 16 sends the second computing entity 14 a confirmation 35 of the real-time digital asset-based interaction. If the interaction initiation is terminated (e.g., interaction initiation fails and/or is cancelled by the first and/or the second computing entity) within a certain amount of time prior to the digital asset-based interaction computing entity 16 continuing with the following steps of the real-time digital asset-based interaction loop 28, the ACK is not generated, and the confirmation 35 of the digital asset-based interaction is not sent.

Within the nonreal-time digital asset-based interaction loop 30, when the ACK is not generated, the method continues with step 44 where the digital asset-based interaction computing entity 16 instructs the digital asset backing computing entity 20 to release the amount of locked system digital asset. Within the real-time digital asset-based interaction loop 28, when the ACK is generated, the method continues with step 37 where, after a time period (e.g., up to 5 minutes), the amount of digital asset 46 is obtained. For example, an initial amount of digital asset is received at a time T1, and an additional amount of digital asset (e.g., tip is added) is received at a time T2 where the initial amount and the additional amount equal the amount of digital asset 46.

The method continues with step 38 where the digital asset-based interaction computing entity 16 exchanges (or connects to a digital asset exchange to exchange) the amount of the digital asset 46 received from the first computing entity 12 to an amount of asset in the desired asset format. Alternatively, if the locked system digital asset is used for the exchange, the digital asset-based interaction computing entity 16 exchanges the amount of the digital asset 46 received from the first computing entity 12 to an amount of system digital asset. The digital asset-based interaction computing entity 16 sends the amount in the desired asset format 48 to the second computing entity 14 to complete the real-time digital asset-based interaction.

Within the nonreal-time digital asset-based interaction loop 30, after the amount of digital asset 46 is obtained at step 37, the method continues with step 40 where the digital asset-based interaction computing entity 16 verifies the amount of the digital asset 46 received from the first computing entity 12. For example, the digital asset-based interaction computing entity 16 connects to a consensus network that verifies the amount of the digital asset received from the first computing entity 12. The consensus network implements a verification process that may take minutes to hours of time.

When the digital asset-based interaction computing entity 16 verifies the amount of the digital asset received by the first computing entity 12 at step 40, the method continues to step 44 where the digital asset-based interaction computing entity 16 instructs the digital asset backing computing entity 20 to release the amount of system digital asset locked for the digital asset-based interaction. When the digital asset-based interaction computing entity 16 does not verify the amount of the digital asset received by the first computing entity 12 at step 40, the method continues to step 42 where the digital asset-based interaction computing entity 16 instructs the digital asset backing computing entity 20 to consume the amount of system digital asset locked for the real-time digital asset-based interaction. Consuming the amount of system digital asset means that the digital asset backing computing entity 20 transfers the amount of system digital asset to an address controlled by the digital asset-based interaction computing entity 16 in order to cover the amount of the real-time digital asset-based interaction.

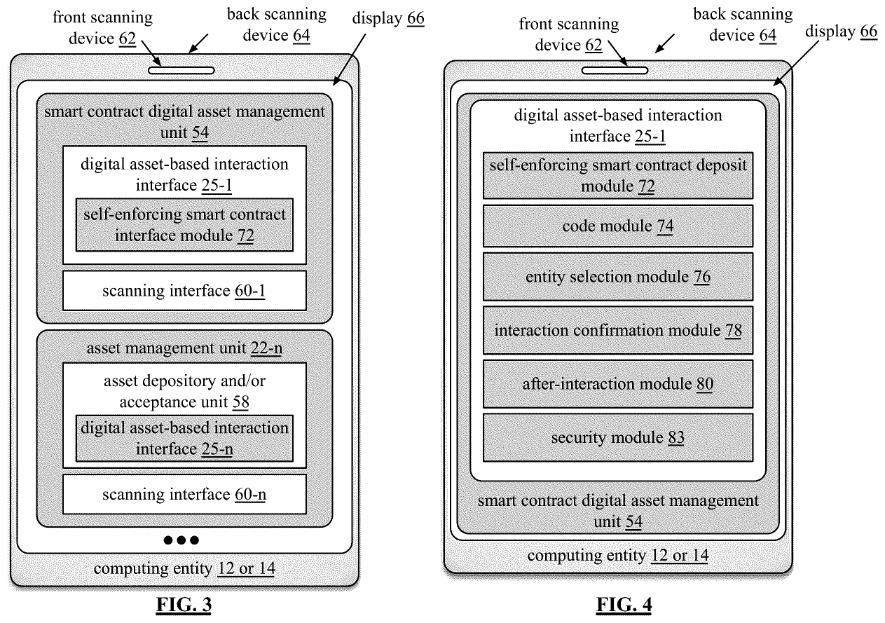

FIG. 3 is a schematic block diagram of an embodiment of a computing entity 12 or 14 of a digital asset-based interaction system. The computing entity 12 or 14 may be the first or second computing entity 12 or 14 of FIGS. 1-2A. In this example, the computing entity 12 or 14 includes a smart contract digital asset management unit 54, a display 66, a front scanning device 62 (e.g., a front camera), and a back scanning device 64 (e.g., a back camera).

A scanning device may be a video device, a camera, an infrared (IR) device, a barcode scanner, etc. The computing entity 12 or 14 may have more or less scanning devices than shown. Further, the scanning devices may be located in different positions on the first computing entity 12 than what is shown. The display 66 may be a liquid crystal display (LCD), a light emitting diode (LED), and/or other type of display technology. The display 66 may include touchscreen functionality implemented by 5-wire resistive, thin film transistor (TFT), in-place switching (IPS), surface capacitive, surface acoustic wave (SAW), infrared, and/or any other type of touch sense and/or touchscreen technology.

The computing entity 12 or 14 may include one or more other asset management units. An asset management unit 22-n includes an asset depository and/or acceptance unit 58 and a scanning interface 60-n. In this example, the asset depository and/or acceptance unit 58 is included in asset depository and/or acceptance unit 58 and stores and/or shows a representation of stored digital assets (e.g., when the digital assets are custodied by a digital asset management computing entity associated with the asset management unit 22). For example, the asset depository and/or acceptance unit 58 is a digital wallet and a “pay” icon and/or button within the digital wallet asset depository and/or acceptance unit 58 links to the digital asset-based interaction interface 25-n. The digital asset-based interaction interface 25-n may automatically open when the “pay” icon is selected (e.g., when the asset management unit 22-n maintains an active link to the digital asset-based interaction computing entity 16) or the user of the computing entity may be prompted to sign into the digital asset-based interaction system (e.g., when the asset management unit 22 does not maintain an active link to the digital asset-based interaction computing entity 16).

A digital wallet “stores” digital assets by generating and holding public and private keys (e.g., a custodial digital wallet manages the private keys for a user and a non-custodial wallet requires a user manage their own private keys) and can create and broadcast transactions on a user's behalf. Here, the digital wallet stores cryptocurrency A 66, cryptocurrency B 68, and token X 70. The digital wallet could store more or less digital assets and may include additional features for digital asset management. For example, the digital wallet may include functions and/or features for trading, exchange, deposit, withdrawal, market information, digital asset news, etc.

In another example, the asset depository and/or acceptance unit 58 is POS hardware and/or software that facilitates receiving assets from other computing entities and may or may not store and/or manage digital assets. The asset depository and/or acceptance unit 58 may include a variety of existing payment processing features for processing payments within existing payment networks. When the computing entity 12 or 14 is a merchant application installed on a user device or merchant e-commerce website accessed by a user device, the asset depository and/or acceptance unit 58 may be an e-commerce platform with POS features.

The smart contract digital asset management unit 54 includes a digital asset-based interaction interface 25-1 and a scanning interface 60-1. The smart contract digital asset management unit 54 is similar to the asset management unit 22-n except that instead of managing digital assets with a digital wallet that generates and holds public and private keys, the smart contract digital asset management unit 54 manages digital assets via a self-enforcing smart contract.

The self-enforcing smart contract is smart contract code hosted on a blockchain. The self-enforcing smart contract does not have a private key and therefore cannot initiate a transaction on the blockchain. Because it does not have a private key, the self-enforcing smart contract is not “owned” by a user but by the logic of the smart contract code itself. In response to a transaction, the self-enforcing smart contract 52 can execute code and/or send messages to other contracts on the blockchain. Unlike a non-custodial wallet, a user is unable to initiate a transaction and therefore is unable to perform malicious acts such as double spend and/or otherwise cheat the smart contract digital asset management unit 54.

The digital asset-based interaction interfaces 25-1 interfaces with the digital asset-based interaction computing entity to facilitate digital asset-based interactions and includes a self-enforcing smart contract interface module 72. The self-enforcing smart contract interface module 72 includes functionality for depositing, withdrawing, and/or otherwise managing digital assets via the self-enforcing smart contract.

The scanning interfaces 60-1 and 60-n are coupled to one or more of the front and/or back scanning devices 62-64 and includes image capturing, image display, image processing, and/or encoding/decoding circuitry operable to capture, display, and/or analyze optically scanned, saved (e.g., a screenshot of a code, a code stored in a memory) or otherwise detected image data such as graphical coded representations of data (e.g., barcodes).

The digital asset-based interaction interfaces 25-1 and 25-n may be included in a respective scanning interface 60-1 and 60-n such that when a scan function is initiated by the scanning interface 60-1 and 60-n, the digital asset-based interaction interface 25-1 and 25-n is accessed. A scan function may be initiated by selecting a scan icon or automatically when certain scannable codes are detected, and an automatic scan to interact function is enabled. The digital asset-based interaction interfaces 25-1 and 25-n may automatically open when the scan function is initiated (e.g., when the smart contract digital asset management unit 54 and/or the asset management unit 22 maintains an active link to the digital asset-based interaction computing entity 16) or the user of the computing entity may be prompted to sign into the digital asset-based interaction system (e.g., when the smart contract digital asset management unit 54 and/or the asset management unit 22 does not maintain an active link to the digital asset-based interaction computing entity 16).

FIG. 4 is a schematic block diagram of an embodiment of a computing entity 12 or 14 of a digital asset-based interaction system that includes a smart contract digital asset management unit 54, a display 66, a front scanning device 62 (e.g., a front camera), and a back scanning device 64 (e.g., a back camera). FIG. 4 operates similarly to FIG. 3 and shows the digital asset-based interaction interface 25-1 of the smart contract digital asset management unit 54 in more detail.

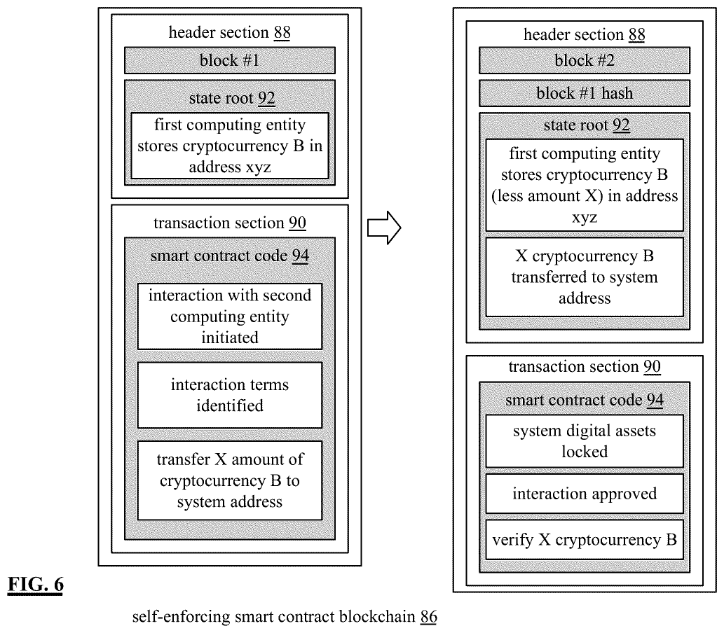

FIG. 4 depicts modules of the digital asset-based interaction interface 25-1 that include a self-enforcing smart contract interface module 72, a code module 74, an entity selection module 76, an interaction confirmation module 78, an after-interaction module 80, and a security module 83. More or less modules are possible. For example, the entity selection module 76 may not be necessary when the entity (e.g., merchant) selection functionality is included in other features and/or components. The self-enforcing smart contract interface module 72 provides a user interface to make deposits into the self-enforcing smart contract 52 for a digital asset-based interaction and/or for general storage. The self-enforcing smart contract interface module 72 will be discussed in further detail with reference to FIG. 5.

The self-enforcing smart contract interface module 72 is operable to display balance information of the digital assets held in the self-enforcing smart contract (or a default digital asset selected for use in digital asset-based interaction system interactions) and is operable to communicate with the self-enforcing smart contract to adjust digital assets (e.g., withdrawal, deposit, etc.) based on digital asset-based interaction system interactions. The balance information is based on rate quotes determined by a digital asset exchange used by the digital asset-based interaction computing entity at a point in time (e.g., a current exchange rate, an average exchange rate for a time period, etc.).

The digital asset-based interaction computing entity is operable to exchange a variety of digital assets (e.g., fiat currency, cryptocurrency, etc.) and to facilitate exchange across jurisdictions (e.g., for foreign currency exchange). The balance information is updated as exchange rates fluctuate and/or based on a predetermined time (e.g., every 30 minutes, once a day, every time a user of the computing entity 12 or 14 opens digital asset-based interaction interface 25, etc.). The balance information may be shown in terms of US dollars or in any other desired digital asset.

The code module 74 is coupled to the scanning interface 60, the front scanning device 62, and/or the back scanning devices 64 of the computing entity 12 or 14 and includes software for detecting and analyzing scannable codes captured by the front and/or back scanning devices 62-64. The code module 74 is operable to receive codes (e.g., from the digital asset-based interaction computing entity), scan scannable codes (e.g., capture via the front and/or back optical scanner 62-64, digitize, and bring into a frame of reference), display scannable codes on the display 66, interpret codes to determine interaction information, and display the interaction information interpreted from the codes. The code module 74 may be a function of the scanning interface 60 that is tailored for scanning and interpreting scannable codes associated with digital asset-based interaction system interactions.

The entity selection module 76 is operable to connect to the digital asset-based interaction computing entity and/or a database associated with the digital asset-based interaction computing entity to receive digital asset-based interaction system entity data (e.g., a list of merchants and/or users associated with the digital asset-based interaction system). The entity selection module 76 may display a list of merchants and/or users that are associated with the digital asset-based interaction system for selection by the computing entity 12 or 14. The entity selection module 76 includes a search function to allow a user to search for a desired merchant and/or user. The displayed list of merchants and/or users may be based on location (e.g., nearby users and/or merchants are listed), category (e.g., restaurant merchants are listed), interaction data (e.g., users associated with a requested interaction are displayed), relationship (e.g., users that have been previously connected to and/or are authorized for contact), and/or availability (e.g., according to merchant hours of operation).

The interaction confirmation module 78 includes options for confirming an interaction and adding additional information (e.g., shipping information, bill splitting options, etc.) prior to confirming an interaction. The after-interaction module 80 includes after-interaction options that can be selected after an interaction is authorized and/or confirmed. For example, the after-interaction module 80 includes functions for an interaction adjustment (e.g., change wallets, change digital asset, etc.), adding additional information (e.g., a shipping address), bill splitting, and adding tip. The after-interaction module 80 information is operable to communicate with the self-enforcing smart contract interface module 72 in order to send data inputs to the self-enforcing smart contract.

The security module 83 includes security mechanisms for authenticating the user and/or user activity of the computing entity 12 or 14 for a digital asset-based interaction. For example, the security module 83 uses facial recognition technology to perform a facial scan prior to initiating an interaction. As another example, the security module 83 stores and/or verifies usernames, passcodes, and/or keys related to authorization of digital asset-based interactions by the computing entity 12 or 14.

FIG. 5 is a schematic block diagram of an embodiment of smart contract digital asset management unit 54 of a computing entity. The smart contract digital asset management unit 54 of FIG. 5 operates similarly to the smart contract digital asset management unit 54 of FIGS. 3 and 4 except that the smart contract digital asset management unit 54 of FIG. 5 is highlighting the functionality of the self-enforcing smart contract interface module 72. The smart contract digital asset management unit 54 includes a digital asset-based interaction interface 25-1. The digital asset-based interaction interface 25-1 interfaces with the digital asset-based interaction computing entity to facilitate digital asset-based interactions.

The digital asset-based interaction interface 25-1 may automatically open when a “pay” icon of the smart contract digital asset management unit 54 is selected (e.g., when the smart contract digital asset management unit 54 maintains an active link to the digital asset-based interaction computing entity 16) or the user of the user computing device 12 may be prompted to sign into the digital asset-based interaction system (e.g., when the smart contract digital asset management unit 54 does not maintain an active link to the digital asset-based interaction computing entity 16).

In this simplified example of the digital asset-based interaction interface 25-1, the digital asset-based interaction interface 25-1 includes access to a self-enforcing smart contract 52 via a self-enforcing smart contract interface module 72. The self-enforcing smart contract is associated with an address “xyz” in the example and is hosted on a self-enforcing smart contract blockchain 86 (e.g., Ethereum). The self-enforcing smart contract interface module 72 is shown from a user interface perspective and shows options to deposit digital assets, withdraw digital assets, and send digital assets for an interaction. Other options are possible (e.g., to initiate an interaction, transfer digital assets, etc.). The send digital assets for interaction option may simply be “pay” icon that displays when an interaction has been initiated (e.g., an entity is selected, a code is scanned, etc.).

In this example, the user has selected to deposit digital assets to the self-enforcing smart contract. A deposit selection may prompt the user to purchase digital assets via a connection to a digital asset exchange or transfer digital assets from another asset management unit or smart contract. Follow up prompts are initiated to determine the amount and type of digital asset the user wishes to deposit and whether the deposit is for a digital asset-based interaction (e.g., a deposit may trigger a digital asset-based interaction). For example, the user has selected to deposit an amount of cryptocurrency B into the self-enforcing smart contract 16.

The self-enforcing smart contract 16 executes in accordance with terms and conditions set by the digital asset-based interaction system to control deposits to, withdrawals from, and transfers from the self-enforcing smart contract 16. Data inputs to the self-enforcing smart contract 52 add additional code (e.g., terms and conditions). Data inputs may be sent by the first and/or second computing entities and/or the digital asset-based interaction computing entity. Data inputs indicate one or more of an initiation of a digital asset-based interaction, information pertaining to a digital asset-based interaction, and computing entity requests and/or instructions regarding digital asset management.

For example, the information pertaining to the digital asset-based interaction includes an amount of the digital asset-based interaction, an item involved in the digital asset-based interaction, an amount of system digital assets locked (or that needs to be locked) for the digital asset-based interaction, the type of digital asset used by the first computing entity, the type of the desired asset requested by the second computing entity, and/or identifiers of the computing entities involved in the digital asset-based computing entity.

The computing entity requests and/or instructions regarding digital asset management include a request to deposit, a request to withdraw, a request to send digital assets to transfer digital assets to the digital asset-based interaction computing entity, and/or a request to transfer digital assets to another address. The computing entity requests must be in accordance with the self-enforcing contract terms and conditions. For example, the computing entity is not able to transfer digital assets without making the request and having the self-enforcing smart contract execute the transfer (e.g., the user of the computing entity does not make control the transfer).

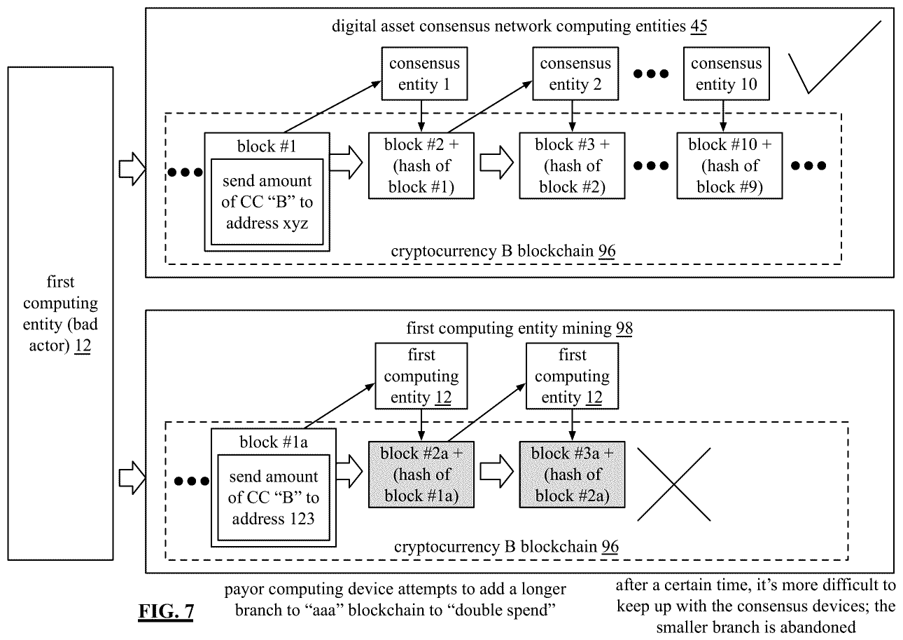

FIG. 6 is a schematic block diagram of an embodiment of a self-enforcing smart contract blockchain 86. A self-enforcing smart contract is a self-enforcing agreement written in computer code that can be embedded in distributed ledger technology (DLT). For example, a blockchain such as the Ethereum blockchain is operable to manage, execute, and/or run smart contracts. A smart contract contains a set of conditions under which the parties to the self-enforcing smart contract agree to interact. The code and the conditions can be publicly or privately available on the ledger. When an event outlined in the self-enforcing smart contract is triggered, the code is executable (e.g., automatically or based on a data input instructing the code to execute).

A self-enforcing smart contract is written to a blockchain or similar database implementation, and executable by consensus network computing entities. For example, the self-enforcing smart contract is a smart contract on the Ethereum blockchain. While a blockchain example is shown here, other distributed ledger technologies are possible to manage, run, and/or execute the self-enforcing smart contract code. When an event outlined in the self-enforcing smart contract is triggered, the code is executable. Therefore, a self-enforcing smart contract runs exactly as programmed without any possibility of censorship, downtime, fraud, or third party interference.

The Ethereum blockchain is a distributed blockchain network that is able to run programming code of any decentralized application through the use of Turing complete software. The self-enforcing smart contract blockchain 86 shown is based on a simplified version of an Ethereum blockchain. An Ethereum block includes a header section 88 and a transaction section 90. The structure of the Ethereum blockchain is similar to the structure of other traditional blockchains such as Bitcoin in that it is a shared record of the entire transaction history.

However, an Ethereum block stores not only transactions that have been collected since the last block in the blockchain was mined (like in Bitcoin) but also the recent “state” of each self-enforcing smart contract. A consensus network (i.e., a network of miners) is responsible for shifting the self-enforcing smart contract from state to state. The header section 88 includes these states in a root hash value (i.e., the state root 92) which summarizes the state changes. The header section 88 further includes other identifying information such as a block number and a hash of a previous block.

The transaction section 90 in Ethereum includes a nonce (a unique transaction identifier), an address of a recipient account, a value, a sending account's signature, code to be run (e.g., smart contract code 94), mining related fields (e.g., start gas and gas price), and possibly some data (e.g., input values for the code). Here, the transaction section 90 is shown as including the smart contract code 94 for simplicity.

FIG. 6 depicts an example of executing a digital asset-based interaction between a first and second computing entity using the smart contract digital asset management unit and continuing the example of FIG. 5 where the self-executing contract stores cryptocurrency B for the first computing entity. In this example, a first computing entity is using cryptocurrency B for the interaction and the second computing entity accepts a desired asset (e.g., a desired cryptocurrency, fiat currency, etc.). For simplicity, the executing the digital asset-based interaction begins with block #1 although numerous blocks would proceed this block. The header section 88 of block #1 includes a state root 92 which includes a current summary of the states of the accounts of the system.

Here, state root 92 includes an entry that the first computing entity stores cryptocurrency B in address “xyz” of the self-enforcing smart contract where the address xyz is associated with the first computing entity. The transaction section 90 of block #1 includes smart contract code 94 which includes code for identifying that a digital asset-based interaction has been initiated (e.g., as identified by a data input by the digital asset-based interaction computing entity) and identifying the terms of the interaction (e.g., how much is owed, the item involved in the interaction, the type of assets involved, the parties involved, etc.). The smart contract code 94 further includes code to transfer X amount of cryptocurrency B to a system address (e.g., a self-enforcing smart contract address associated with the digital asset-based interaction computing entity). As block #1 is mined, the smart contract code 90 of block #1 runs.

The header section 88 of block #2 includes a hash of block #1 and a state root 92. The state root 92 includes information pertaining to the current state of the self-enforcing smart contract accounts. For example, the state root 92 of block #2 states that the first computing entity stores cryptocurrency B in address “xyz” (less the X amount), and that X amount of cryptocurrency B are transferred to the system address.

The transaction section 90 of block #2 includes smart contract code 94 indicating that an amount of system digital assets have been locked to back the digital asset-based interaction. For example, the digital asset-based interaction computing entity provides a data input to the self-enforcing smart contract that the amount of system digital assets have been locked. The transaction section 90 of block #2 also includes smart contract code 94 indicating that the digital asset-based interaction is approved based on the fact that the system digital assets have been locked.

For example, data input provided by the digital asset-based interaction computing entity indicating that the amount of system digital assets have been locked also indicates that the digital asset-based interaction is approved. The transaction section 90 of block #2 also includes smart contract code 94 to verify the X cryptocurrency B. The verification occurs on the cryptocurrency B blockchain. For example, the self-enforcing smart contract is operable to send and obtain data inputs from the cryptocurrency B blockchain to verify the transfer. As block #2 is mined, the smart contract code 94 of block #2 runs.

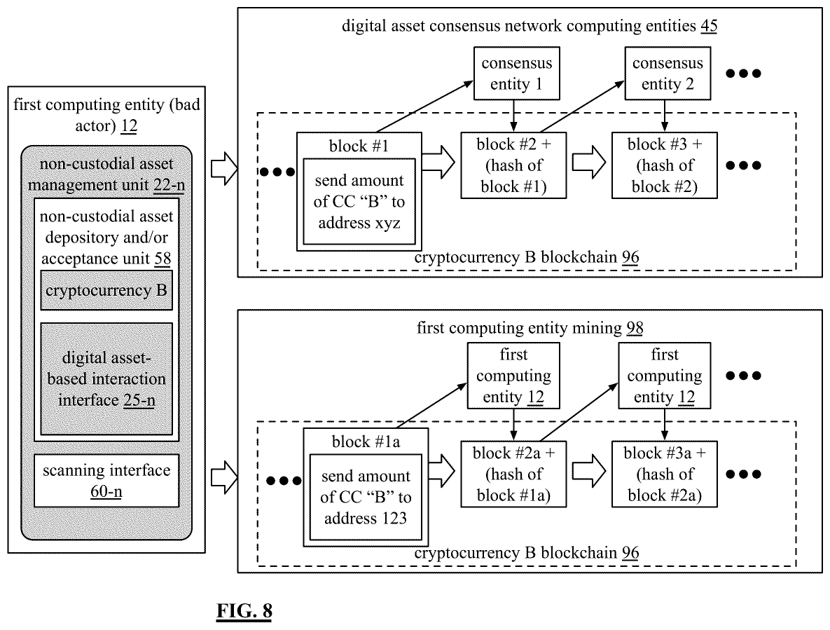

FIG. 7 is a schematic block diagram of an example of an attempted fraudulent digital asset-based interaction within the digital asset-based interaction system from the perspective of the digital asset-based interaction computing entity. In this example, the first computing entity 12 is a bad actor attempting to “double spend” on the cryptocurrency B blockchain 96. Using a traditional asset management unit, the first computing entity 12 transfers cryptocurrency B to a digital asset-based interaction computing entity to complete the interaction with the second computing entity 14 (block #1), in this example, the first computing entity 12 simultaneously adds block #la to the cryptocurrency B blockchain 96 to send the same cryptocurrency B to a different address (e.g., address 123).

In this example, block #1 is mined by the digital asset consensus network computing entities 45 that includes consensus computing entities 1-10 and eventually receives 10 confirmations (e.g., enough confirmations for the digital asset-based interaction computing entity to verify the interaction). Attempting a 51% attack on a proof-of-work blockchain, the first computing entity 12 attempts to mine block #1 a to add a longer branch to the cryptocurrency B blockchain than the block #1 chain. The longest version of the blockchain is deemed valid by the network consensus rules. Therefore, if payor computing device 12 is successful, the block #1 transaction would receive enough confirmations to be confirmed (e.g., 10 in this example) but then would be abandoned by a self-mined longer branch for block #la which would also be confirmed.

However, mining blocks takes a significant amount of computing power and after a certain amount of time, the first computing entity 12 cannot keep up with other consensus computing entities. In this example, the first computing entity 12 is able to complete three confirmations of block #1 a in the time it takes the other consensus devices to complete ten confirmations of block #1. Because the block #1 chain is longer, the digital asset consensus network computing entities 45 adopts it as correct and the shorter chain for block #1 a is abandoned.

FIG. 8 is a schematic block diagram of an example of an attempted fraudulent digital asset-based interaction within the digital asset-based interaction system from the perspective of a non-custodial asset management unit 22-n. The non-custodial asset management unit 22-n includes a non-custodial asset depository and/or acceptance unit 58 (e.g., a non-custodial wallet application) that is storing a cryptocurrency B. In this example, the first computing entity 12 transfers cryptocurrency B to the digital asset-based interaction computing entity via the non-custodial asset management unit 22-n to complete the interaction with the second computing entity 14 (block #1), in this example, the first computing entity 12 simultaneously adds block #la to the cryptocurrency B blockchain 96 to send the same cryptocurrency B to a different address (e.g., address 123).

Block #1 is mined by the digital asset consensus network computing entities 45 that includes consensus computing entities 1-10. Attempting a 51% attack on a proof-of-work blockchain, the first computing entity 12 attempts to mine block #la to add a longer branch to the cryptocurrency B blockchain than the block #1 chain. The longest version of the blockchain is deemed valid by the network consensus rules. Therefore, if payor computing device 12 is successful, the block #1 transaction would receive enough confirmations to be confirmed (e.g., 10 in this example) but then would be abandoned by a self-mined longer branch for block #la which would also be confirmed.

With a non-custodial asset management unit 22-n, the first computing entity 12 maintains control of the private keys to the non-custodial asset depository and/or acceptance unit and controls the transfers to and from the non-custodial asset depository and/or acceptance unit. Unlike the digital asset-based interaction computing entity, where the digital asset-based interaction computing entity waits for a certain amount of confirmations to approve a transaction, from a non-custodial asset management unit's perspective, once the double transaction is made, the non-custodial asset management unit is “cheated.” As such, from the non-custodial asset management unit's 22-n perspective, double spending is a possibility. To prevent double spending, the non-custodial asset management unit's 22-n implements other security measures to prevent and/or mitigate fraudulent digital asset-based interactions. Within the digital asset-based interaction system, if the verification process fails due to double spending, system digital assets (such as those deposited by the developer of the non-custodial asset management unit) will be consumed.

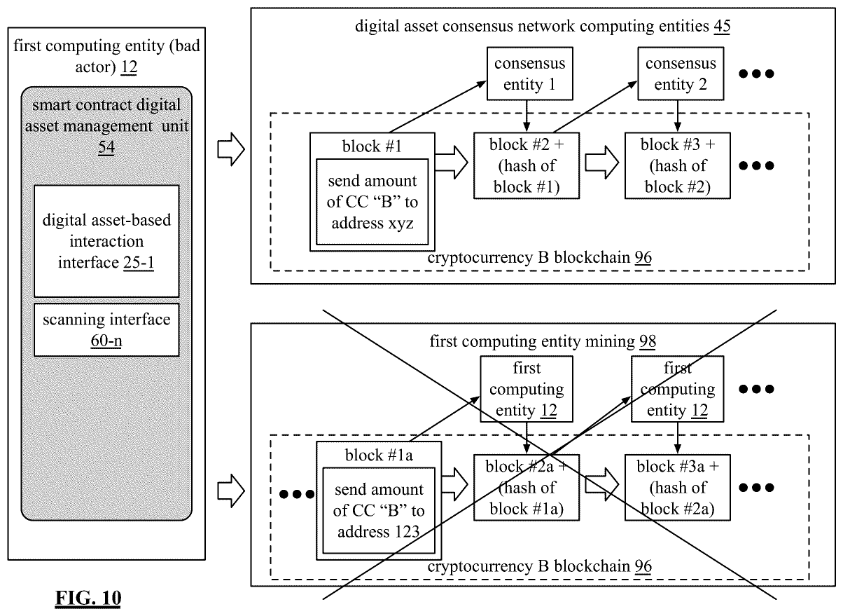

FIG. 9 is a schematic block diagram of an example of an attempted fraudulent digital asset-based interaction within the digital asset-based interaction system from the perspective of a custodial asset management unit 22-c. The custodial asset management unit 22-c includes a custodial asset depository and/or acceptance unit 58 (e.g., a custodial wallet application) that is storing a cryptocurrency B. In this example, the first computing entity 12 transfers cryptocurrency B to the digital asset-based interaction computing entity via the custodial asset management unit 22-c to complete the interaction with the second computing entity 14 (block #1).

With a custodial asset management unit 22-c, the first computing entity 12 does not maintain control of the private keys to the custodial asset depository and/or acceptance unit and while transfers can be initiated by the first computing entity 12, they are executed by the custodial asset management unit 22-c. As such, from the custodial asset management unit's 22-n perspective, double spending is not possible because the custodial asset management unit's 22-n would not process the first computing entity's 12 attempt to simultaneously add block #la to the cryptocurrency B blockchain 96 to send the same cryptocurrency B to a different address (e.g., address 123).

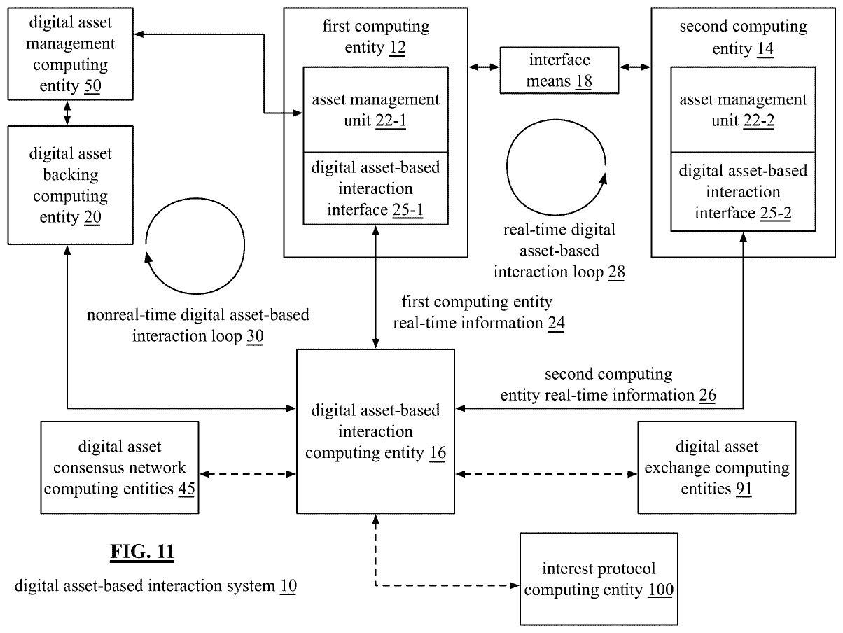

FIG. 10 is a schematic block diagram of an example of an attempted fraudulent digital asset-based interaction within the digital asset-based interaction system from the perspective of a smart contract digital asset management unit 54. The smart contract digital asset management unit 54 includes a digital asset-based interaction interface 25-1 that communicates with a self-enforcing smart contract to transfer cryptocurrency B to the digital asset-based interaction computing entity to complete an interaction with the second computing entity 14 (block #1).

The first computing entity 12 is not operable to double spend on the self-enforcing smart contract because the first computing entity 12 cannot perform a transfer. The first computing entity 12 can initiate an interaction which is one or more data points to the self-enforcing smart contract but the self-enforcing smart contract self-executes in accordance with smart contract code that the first computing entity 12 is not in control over. As such, from the smart contract digital asset management unit's 54 perspective, double spending is not possible. However, unlike a custodial asset management unit 22-c, the first computing entity 12 would not need to provide personal data (e.g., bank account information, address and proof of address, a photo ID, etc.) to use the smart contract digital asset management unit 54 or relinquish control over assets to another entity.

FIG. 11 is a schematic block diagram of another embodiment of a digital asset-based interaction system 10 that includes a first computing entity 12, a second computing entity 14, a digital asset-based interaction computing entity 16, an interface means 18, a digital asset backing computing entity 20, a digital asset management computing entity 50, one or more digital asset exchange computing entities 91, one or more digital asset consensus network computing entities 45, and an interest protocol computing entity 100. The digital asset-based interaction system 10 of FIG. 11 operates similarly to the digital asset-based interaction system 10 of FIG. 1 except that the digital asset-based interaction system 10 of FIG. 11 includes the interest protocol computing entity 100.

The interest protocol computing entity 100 is a computing entity that manages an interest generating smart contract running on a smart contract enabled blockchain. For example, the smart contract enabled blockchain is the Ethereum blockchain. The digital asset-based interaction computing entity 16 interacts with the interest protocol computing entity 100 to provide digital assets and/or system digital assets received from one or more computing entities of the digital asset-based interaction system 10 to an interest generating smart contract of the interest protocol computing entity 100. The digital assets stored in the interest generating smart contract form a liquidity pool of the interest protocol computing entity 100. Contributor computing entities such provide digital assets to the liquidity pool and earn interest on provided digital assets. Borrower computing entities are operable to borrow digital assets from the liquidity pool and in exchange, provide interest to the interest protocol computing entity 100. In this example, the digital asset-based interaction computing entity 16 is a contributor computing entity.

For every block on the interest generating smart contract, borrower computing entities provide interest on borrowed digital assets and contributor computing entities earn interest on supplied digital assets in accordance with an interest generating protocol. The interest generating protocol determines the amount of interest owed and/or earned based on the type of the digital assets, a length of time, the number of blocks on the smart contract enabled blockchain (e.g., where interest accrues on a block-by-block basis), and the amount of digital assets borrowed and/or contributed.

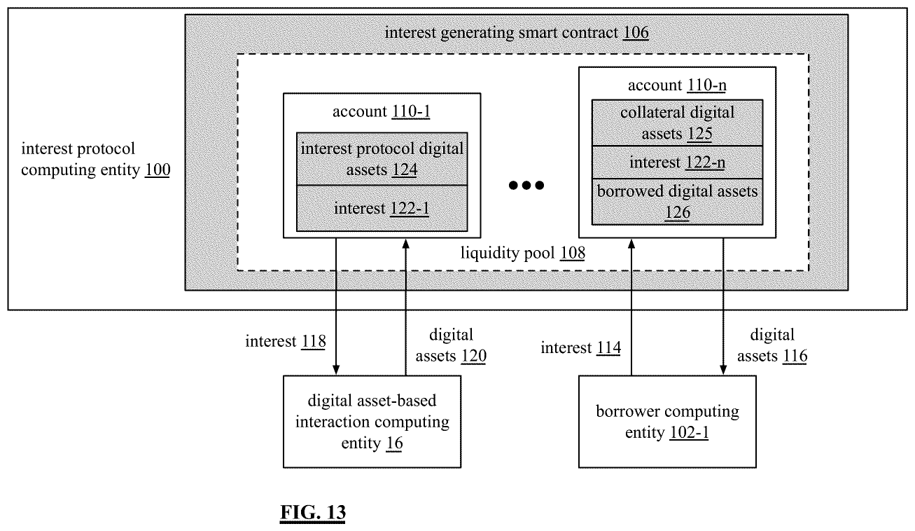

When the digital asset-based interaction computing entity 16 requests a withdrawal of digital assets from the interest protocol computing entity 100, the interest generating smart contract determines an amount of interest owed to the digital asset-based interaction computing entity 16 based on the interest generating protocol and provides the amount of the interest and the digital assets to the digital asset-based interaction computing entity 16. The digital asset-based interaction computing entity 16 is operable to use the interest as rewards to depositors (e.g., staking entities, individual computing devices, etc.) and/or to cover transaction fees of the digital asset-based interaction system 10. Covering transaction fees reduces transaction fees and/or produces a transaction fee-less digital asset-based interaction system 10. The interest protocol computing entity 100 will be discussed in greater detail with reference to FIGS. 12-16.

FIG. 12 is a schematic block diagram of an embodiment of an interest protocol computing entity 100 interacting with borrower computing entities 102-1 through 102-n and contributor computing entities 104-1 through 104-n. In this example, the digital asset-based interaction entity 16 is a contributor computing entity. The interest protocol computing entity 100 is a computing entity that manages an interest generating smart contract 106 running on a smart contract enabled blockchain.

The contributor computing entities 104-1 through 104-n provide digital assets 120 to the interest generating smart contract 106 to form liquidity pool(s) 108 and the borrower computing entities 102-1 through 102-n borrow digital assets 116 from the liquidity pool(s) 108. The liquidity pool(s) 108 include one or more liquidity pools of one or more types of digital assets where an interest rate is determined for each type of digital asset.

In this example, the interest generating smart contract 106 includes accounts 110-1 through 110-n that are storing digital assets 112-1 through 112-n. For example, when a contributor computing entity provides digital assets 120 to the interest generating smart contract 106, an account pertaining to the contributor computing entity is generated that keeps track of the contributor computing entity's stored digital assets, generated interest 122-1 through 122-n, and/or other information. As another example, when a borrower computing entity 102 borrows digital assets 116 from the interest generating smart contract 106, an account pertaining to the borrower computing entity is generated that keeps track of the borrower computing entity's borrowed digital assets, stored interest 122-1 through 122-n, and/or other information.

For every block on the interest generating smart contract, borrower computing entities provide interest on borrowed digital assets and contributor computing entities earn interest on supplied digital assets in accordance with an interest generating protocol. The interest generating protocol determines the amount of interest owed and/or earned based on the type of the digital assets, a length of time, the number of blocks on the smart contract enabled blockchain (e.g., where interest accrues on a block-by-block basis), and the amount of digital assets borrowed and/or contributed.

The digital assets provided 120 and the digital assets 112 stored in the accounts 110-1 through 110-n may be the same or different types of digital assets. For example, the contributor computing entity 104-1 through 104-n provide digital assets 120 which are exchanged for a substantially equivalent amount of interest protocol digital assets. The interest protocol digital assets may be a token on the smart contract enabled blockchain. For example, when the smart contract enabled blockchain is the Ethereum blockchain, the interest protocol digital assets may be ERC20 tokens.

The interest protocol digital assets may be redeemed at an exchange rate according to the underlying digital asset 120 that constantly increases over time based on the interest earned by the underlying digital asset. When the digital asset-based interaction computing entity 16 or another contributor computing entity 104-1 through 104-n requests a withdrawal of digital assets from the interest protocol computing entity 100, the interest generating smart contract 106 determines an amount of interest 118 owed to the digital asset-based interaction computing entity 16 or another contributor computing entity 104-1 through 104-n based on the interest generating protocol and provides the amount of the interest 118 and the digital assets to the digital asset-based interaction computing entity 16 or another contributor computing entity 104-1 through 104-n.

When the digital assets provided 120 and the digital assets 112 stored in the accounts 110-1 through 110-n are different types of digital assets (e.g., the digital assets 112 are interest protocol digital assets), and the digital asset-based interaction computing entity 16 or another contributor computing entity 104-1 through 104-n requests a withdrawal, the digital assets 112 are exchanged for the underlying digital assets 120 based on an exchange rate that accounts for the accrued interest and the type of the underlying digital assets 120.

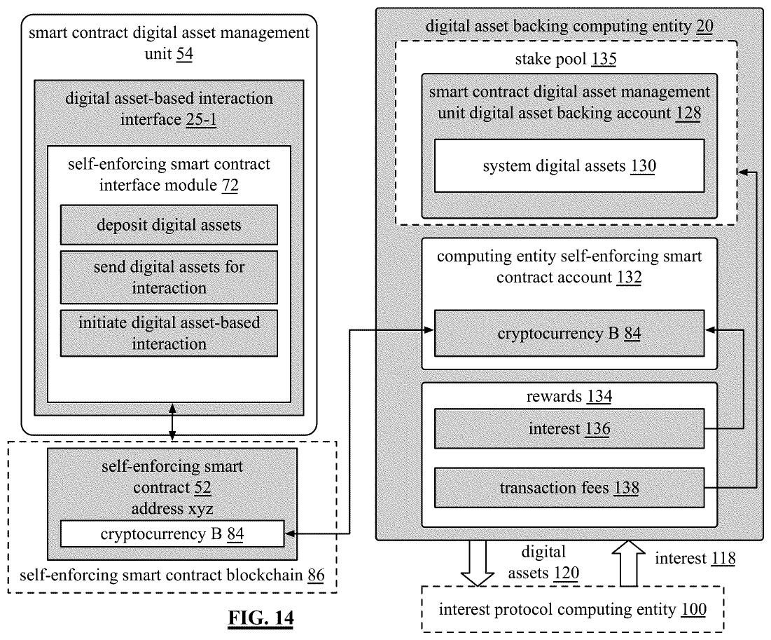

FIG. 13 is a schematic block diagram of an embodiment of an interest protocol computing entity 100 interacting with a digital asset-based interaction entity 16 and a borrower computing entity 102-1. Upon depositing digital assets 120 to the interest generating smart contract 106, the digital assets 120 provided by the digital asset-based interaction computing entity 16 (or other contributor computing entity) are exchanged for a substantially equivalent amount of interest protocol digital assets 124. The interest protocol digital assets 124 may be a token on the smart contract enabled blockchain. For example, when the smart contract enabled blockchain is the Ethereum blockchain, the interest protocol digital assets 124 may be ERC20 tokens. The interest protocol digital assets 124 may be redeemed at an exchange rate according to the underlying digital asset that constantly increases over time based on the interest 122-1 earned by the underlying digital asset.

In this example, the interest generating smart contract 106 includes accounts 110-1 through 110-n. For example, when a digital asset-based interaction entity 16 provides digital assets 120 to the interest generating smart contract 106, an account 110-1 pertaining to the digital asset-based interaction computing entity 16 is generated that keeps track of the digital asset-based interaction computing entity 16's stored digital assets, the increasing exchange rate of interest protocol digital assets 124 to digital assets 120 based on generated interest 122-1, and/or other information.

In an example, in order to borrow digital assets from the interest protocol computing entity 100, a borrower computing entity 102-1 provides collateral digital assets 125 to an account 110-n of the interest generating smart contract 106. Providing collateral digital assets 125 may be similar to providing digital assets as a contributor computing entity where a digital asset is supplied and then exchanged for a substantially equivalent amount of interest protocol digital assets (referred to as the collateral digital assets in this case). Collateral digital assets 125 earn interest similarly to the interest protocol digital assets 124 provided by the digital asset-based interaction computing entity 16 except that when used as collateral for a borrow, the borrower computing entity 102-1 cannot redeem or transfer the collateral digital assets 125.

The maximum amount the borrower computing entity 102-1 can borrow is based on the amount and type of collateral digital assets 125 supplied. For example, a type of collateral digital assets is given a collateral factor based on the value and/or trustworthiness of the collateral digital assets. As a specific example, if a borrower computing entity 102-1 supplies 100 cryptocurrency X as the collateral digital assets and cryptocurrency X has a collateral factor of 50%, the borrower computing entity 102-1 can borrow up to 50 cryptocurrency X. While a borrow is open, the borrow balance is ever increasing and the borrower computing entity 102-1 can choose to repay some or all of the borrow balance at any time. In another example, the borrower computing entity 102-1 is required to repay some or all of the borrow balance at set time periods based on agreed upon terms.

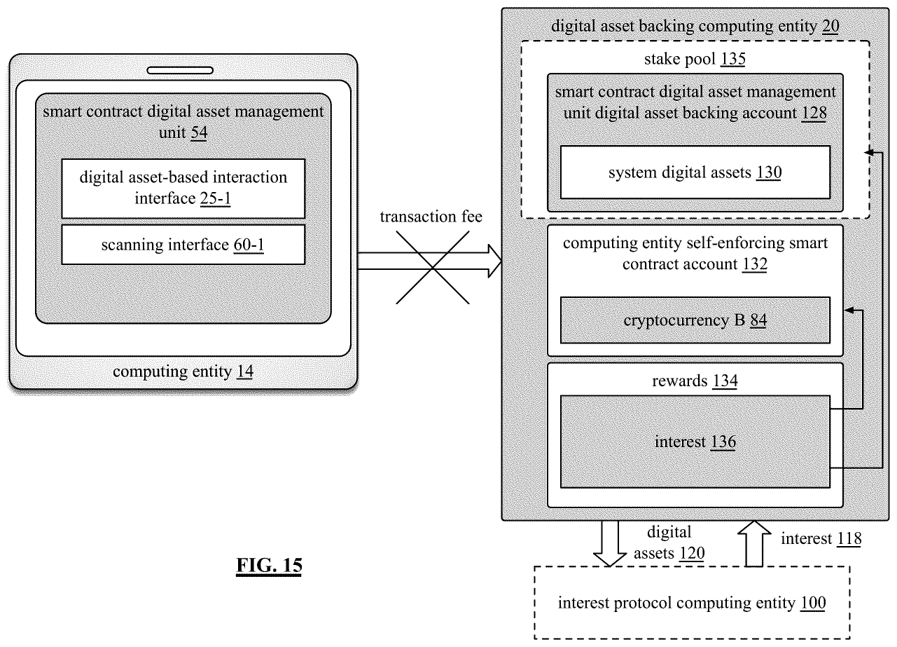

FIG. 14 is a schematic block diagram of an embodiment of smart contract digital asset management unit 54 of a computing entity interacting with a digital asset backing computing entity 20 of a digital asset-based interaction computing entity. The smart contract digital asset management unit 54 includes a digital asset-based interaction interface 25-1. The digital asset-based interaction interface 25-1 interfaces with the digital asset-based interaction computing entity to facilitate digital asset-based interactions.

In this simplified example of the digital asset-based interaction interface 25-1, the digital asset-based interaction interface 25-1 includes access to a self-enforcing smart contract 52 via a self-enforcing smart contract interface module 72. The self-enforcing smart contract is associated with an address “xyz” in the example and is hosted on a self-enforcing smart contract blockchain 86 (e.g., Ethereum). The self-enforcing smart contract interface module 72 is shown from a user interface perspective and shows options to deposit digital assets, send digital assets for an interaction, and initiate a digital asset-based interaction. For example, the send digital assets for interaction option may simply be “pay” icon that displays when an interaction has been initiated (e.g., an entity is selected, a code is scanned, etc.). As another example, the initiate a digital asset-based interaction option may simply be “pay” icon and the selection of the “pay” icon initiates the interaction.

In this example, the user has deposited an amount of cryptocurrency B into the self-enforcing smart contract 16. The self-enforcing smart contract 16 consists of pre-existing code in accordance with the digital asset-based interaction system to control deposits to, withdrawals from, and transfers from the self-enforcing smart contract 16. The self-enforcing smart contract 16 may receive data inputs based on a particular digital asset-based interaction that produce new smart contract code for executing digital asset management based on the digital asset-based interaction.

The digital asset backing computing entity 20 includes a smart contract digital asset management unit digital asset backing account 128 (also referred to herein as a digital asset backing account) that stores system digital assets 130 to back the digital asset-based interactions of the smart contract digital asset management unit 54. The digital asset backing computing entity 20 also includes a computing entity self-enforcing smart contract account 132 that keeps track of digital assets deposited by a user of the smart contract digital asset management unit 54 for the purposes of earning interest.

The digital asset backing computing entity 20 pools the system digital assets 130 from multiple digital asset backing accounts to form a stake pool 135. For every successful transaction, a receiving computing entity (e.g., a merchant) pays a transaction fee 138. The transaction fees 138 are pooled as rewards 134 and are distributed to the stake pool 135 in accordance with individual digital asset backing account information (e.g., an amount of system digital assets deposited, contracted terms, the amount of transactions of an associated asset management unit).

The digital asset backing computing entity 20 may deposit the system digital assets 130 and/or the digital assets deposited by users (e.g., cryptocurrency B 84) to the interest protocol computing entity 100 as digital assets 120. In this example, interest 118 earned by depositing the digital assets 120 with the interest protocol computing entity 100 is pooled as rewards 134 and distributed to individual users in accordance with individual digital asset backing account information. For example, interest earned by depositing system digital assets results in rewards to the stake pool 135 and interest earned by cryptocurrency B deposited by the user of the smart contract digital asset management unit 54 results in rewards to the computing entity self-enforcing smart contract account 132.

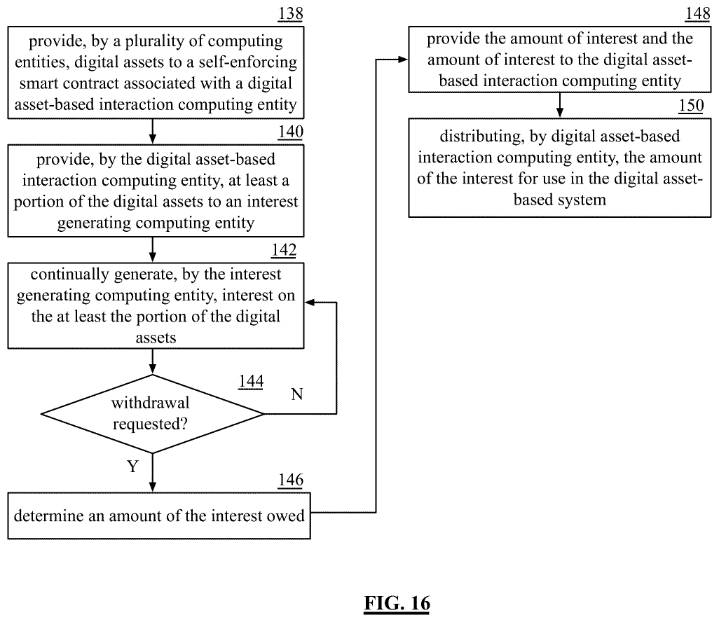

FIG. 15 is a schematic block diagram of an embodiment of smart contract digital asset management unit 54 of a computing entity 14 interacting with a digital asset backing computing entity 20 of a digital asset-based interaction computing entity. FIG. 15 operates similarly to the example of FIG. 14 except that the computing entity 14 is a receiving computing entity (e.g., a merchant) that would typically pay a transaction fee for every successful transaction using the digital asset-based interaction system.

The smart contract digital asset management unit 54 includes a digital asset-based interaction interface 25-1. The digital asset-based interaction interface 25-1 interfaces with the digital asset-based interaction computing entity to facilitate digital asset-based interactions.

The digital asset backing computing entity 20 includes a smart contract digital asset management unit digital asset backing account 128 that stores system digital assets 130 to back digital asset-based interactions of the smart contract digital asset management unit 54 of a sending computing entity (e.g., the first computing entity). The digital asset backing computing entity 20 also includes a computing entity self-enforcing smart contract account 132 that keeps track of digital assets deposited by a user of the smart contract digital asset management unit 54.

The digital asset backing computing entity 20 pools the system digital assets 130 from multiple smart contract digital asset management unit digital asset backing accounts to form a stake pool 135. The digital asset backing computing entity 20 may deposit the system digital assets 130 and/or the digital assets deposited by users (e.g., cryptocurrency B 84) to the interest protocol computing entity 100 as digital assets 120. In this example, interest 118 earned by depositing the digital assets 120 with the interest protocol computing entity 100 is pooled (interest 136) as rewards 134 and distributed to individual user computing entities and/or the stake pool 135 in accordance with individual digital asset backing account information (e.g., the underlying digital assets, the amounts deposited, contracted terms, etc.). When there is enough interest 118 to use as the rewards for both the stake pool 135 and the individual user computing entities, there is no need to charge receiving computing entities a transaction fee or the transaction fees can be reduced). This feature is an improvement over existing payment systems that involve high merchant fees that are partially or fully passed to consumers.

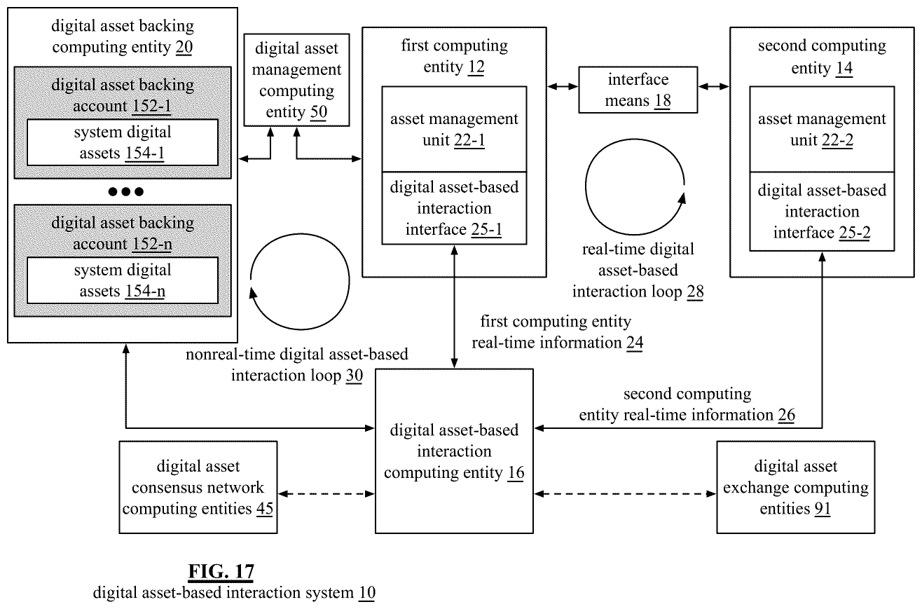

FIG. 16 is a flowchart of an example of a method of generating interest on digital assets of a digital asset-based interaction system. The method begins with step 138 where a plurality of computing entities of the digital asset-based interaction system provides digital assets to a self-enforcing smart contract associated with a digital asset-based interaction computing entity of the digital asset-based interaction system. Providing the digital assets includes depositing and/or transferring digital assets into an account address of the self-enforcing smart contract, sending the digital assets to the digital asset-based interaction computing entity where the digital asset-based interaction computing entity transfers the digital assets to the self-enforcing smart contract, etc. The digital asset-based interaction computing entity facilitates digital asset-based interactions. A digital asset-based interaction includes a real-time digital asset-based interaction process and a nonreal-time digital asset-based interaction process as discussed with reference to FIGS. 1 and 2.

The method continues with step 140 where the digital asset-based interaction computing entity provides at least a portion of the digital assets to an interest protocol computing entity of the digital asset-based interaction system. The interest protocol computing entity is a computing entity that manages an interest generating smart contract running on a smart contract enabled blockchain. Providing the at least a portion of the digital assets includes transferring the at least a portion of the digital assets from a digital asset-based interaction computing entity address (e.g., a digital asset backing account address, a computing entity self-enforcing smart contract account, etc.) to an interest protocol computing entity address, sending the at least a portion of the digital assets to an account associated with the interest protocol computing entity, etc.

One or more contributor computing entities contribute digital assets to the interest protocol computing entity to form a liquidity pool. For example, the digital asset-based interaction computing entity is a contributor computing entity. The liquidity pool includes one or more liquidity pools of one or more types of digital assets where an interest rate is determined for each type of digital asset. One or more borrower computing entities borrow digital assets from the liquidity pool and deposit interest in accordance with the borrowing. Upon depositing digital assets to the interest generating smart contract, the digital asset-based interaction entity (or other contributor computing entity) may receive a substantially equivalent amount of interest protocol digital assets. The interest protocol digital assets may be a token on the smart contract enabled blockchain. For example, when the smart contract enabled blockchain is the Ethereum blockchain, the interest protocol digital assets may be ERC20 tokens. The interest protocol digital assets may be redeemed at an exchange rate according to the underlying digital asset that constantly increases over time based on the interest earned by the underlying digital asset.

The method continues with step 142 where the interest protocol computing entity, via the interest generating smart contract, continually generates interest on the least the portion of the digital assets using an interest generating protocol. For every block on the interest generating smart contract, borrower computing entities provide interest on borrowed digital assets and contributor computing entities earn interest on supplied digital assets in accordance with an interest generating protocol. The interest generating protocol determines the amount of interest owed and/or earned based on the type of the digital assets, a length of time, the number of blocks on the smart contract enabled blockchain (e.g., where interest accrues on a block-by-block basis), and the amount of digital assets borrowed and/or contributed.

When the digital asset-based interaction computing entity requests a withdrawal of an amount of digital assets of the at least the portion of the digital assets at step 144, the method continues with step 146 where the interest protocol computing entity determines an amount of the interest owed to the digital asset-based interaction computing entity based on the interest generating protocol. The interest generating protocol evaluates the type of the amount of digital assets, a length of time, an amount of blocks on the smart contract enabled blockchain, and the amount of the digital assets to determine an amount of interest.

The method continues with step 148 where the interest protocol computing entity provides the amount of the interest and the amount of the digital assets to the digital asset-based interaction computing entity. When the digital asset-based interaction entity received a substantially equivalent amount of interest protocol digital assets, the interest protocol computing entity exchanges a substantially equivalent amount of interest protocol digital assets for the amount of the digital assets in accordance with an exchange rate related to the interest generating protocol (e.g., the exchange rate takes into the type of digital assets, a length of time, an amount of blocks on the smart contract enabled blockchain, and the amount of the digital assets, etc.)

The method continues with step 150 where the digital asset-based interaction computing entity distributes the amount of the interest for use within the digital asset-based interaction system. For example, when the deposited digital assets are provided to digital asset-based interaction computing entity by a computing entity, at least a portion of the interest may go directly to that computing entity as rewards/earnings. In another example, when deposited digital assets are system digital assets from a staking pool of the digital asset-based interaction computing entity, at least a portion of the interest may go to the stake pool to reward staking computing entities. As another example, at least a portion of the interest may be used to cover transaction fees within the digital asset-based interaction system.

When the digital asset-based interaction computing entity does not request a withdrawal of an amount of digital assets of the at least the portion of the digital assets at step 144, the method continues with step 142 where the interest protocol computing entity, and via the interest generating smart contract, continually generates interest on the at least the portion of the digital assets using an interest generating protocol.

FIG. 17 is a schematic block diagram of an embodiment of a digital asset-based interaction system 10 that includes a first computing entity 12, a second computing entity 14, a digital asset-based interaction computing entity 16, an interface means 18, a digital asset backing computing entity 20, a digital asset management computing entity 50, one or more digital asset exchange computing entities 91, one or more digital asset consensus network computing entities 45, and an interest protocol computing entity 100. The digital asset-based interaction system 10 of FIG. 17 operates similarly to the digital asset-based interaction system 10 of FIG. 1 except that the digital asset backing computing entity 20 is shown in more detail.

The digital asset backing computing entity 20 includes a plurality of digital asset backing accounts 152-1 through 152-n that store system digital assets 154-1 through 154-n respectively. The system digital assets 154-1 through 154-n serve as collateral to back digital asset-based interactions of the digital asset-based interaction system 10. The system digital assets may be any digital asset that the digital asset-based interaction system chooses to use. For example, the system digital asset is a token on the Ethereum blockchain specifically created for use in the digital asset-based interaction system. As another example, the system digital asset is an already established and trusted cryptocurrency.

The plurality of digital asset backing accounts 152-1 through 152-n is associated with the first computing entity 12, the second computing entity 14, and/or a type of digital asset. As an example, the digital asset backing account 152-1 is associated with the asset management unit 22-1 of the first computing entity 12. The digital asset management computing entity 50 is associated with the digital asset backing computing entity 20 via one or more accounts and is operable to deposit system digital assets into the one or more accounts to back digital asset-based interactions of users of an associated asset management unit (e.g., asset management unit 22-1). The digital asset management computing entity 50 is incentivized to back asset management unit interactions by receiving rewards from the digital asset backing computing entity 20 such as a percentage of system digital asset back on successful transactions. Additionally, the system digital asset provides payment utility such as lower foreign exchange rates.

The digital asset management computing entity 50 is also referred to as a staking entity and in this example, is associated with a developer of the asset management unit (e.g., a digital wallet developer). Because the digital asset management computing entity 50 is backing the asset management unit interactions and is rewarded by successful transactions, the digital asset management computing entity 50 is incentivized to produce a quality asset management unit that prevents user fraud and to remedy faulty software that affects transaction success. In another embodiment, the asset management units 22 may be backed by a different and/or additional type(s) of staking entities such as one or more user computing devices, one or more merchant computing entities, one or more computing entities associated with a corporation and/or business, etc.

In another embodiment, a staking entity is operable to use any type of digital asset to back asset management unit interactions. The staking entity provides a desired type of digital asset to a digital asset backing account 152-1 through 152-n as collateral to borrow system digital assets. For example, the staking entity deposits an amount of a type of digital asset into a network enabled smart contract in which the terms of the network enabled smart contract will trigger sending the amount of a type of digital asset to the digital asset backing computing entity 20 upon certain events. As another example, the staking entity transfers the amount of a type of digital asset to an associated digital asset backing account 152-1 through 152-n, where the digital asset backing computing entity 20 will send it back to the staking entity upon certain events. Upon providing the amount of a type of digital asset, the staking entity may borrow a substantially equivalent amount of system digital assets to back digital asset-based interactions associated with the staking entity.

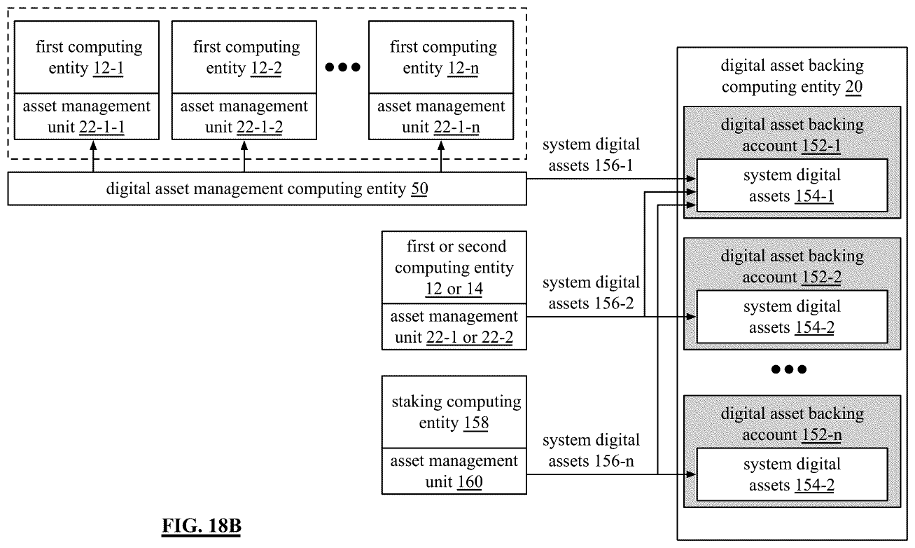

FIGS. 18A-18B are schematic block diagrams of examples of staking entities of a digital asset-based interaction system. In this example, the staking entities include a digital asset management computing entity 50, the first or second computing entity 12 or 14, and a staking computing entity 158. The staking computing entity 158 may be any computing entity such as a user computing device, another digital asset management computing entity, etc.

To become staking entities of the digital asset-based interaction system, the digital asset management computing entity 50, the first or second computing entity 12 or 14, and the staking computing entity 158 deposit system digital assets 156-1 through 156-n in an associated digital asset backing account 152-1 through 152-n of the digital asset backing computing entity 20 to back digital asset-based interactions of the digital asset-based interaction system.

In FIG. 18A, the digital asset management computing entity 50 is associated with a digital asset backing account 152-1 and deposits system digital assets 156-1 to back digital asset-based interactions of asset management units 22-1-1 through 22-1-n of first computing entities 12-1 through 12-n. The first or second computing entity 12 or 14 is associated with a digital asset backing account 152-2 and deposits system digital assets 156-2 to back digital asset-based interactions of the first or second computing entity 12 or 14. The staking computing entity 158 is associated with a digital asset backing account 152-n and deposits system digital assets 156-n to back digital asset-based interactions of the staking computing entity 158.

In FIG. 18B, in addition to the example of FIG. 18B, the first or second computing entity 12 or 14 and the staking computing entity 158 also deposit system digital assets into the digital asset backing account 152-1 to back digital asset-based interactions of asset management units 22-1-1 through 22-1-n of first computing entities 12-1 through 12-n. In another example, the digital asset management computing entity 50 may deposit system digital assets into one or more other accounts to back other digital asset-based interactions of the digital asset-based interaction system. For example, the digital asset management computing entity 50 deposits system digital assets into an account associated with another asset management unit.

The first or second computing entity 12 or 14 and the staking computing entity 158 may also deposit system digital assets into one or more other accounts to back other digital asset-based interactions of the digital asset-based interaction system. For example, the first or second computing entity 12 or 14 may deposit system digital assets into a digital asset backing account associated with another computing entity, a type of digital asset, and/or another asset management unit. For every successful transaction involving the digital asset backing account, the staking entities associated with the digital asset backing account receive a percentage of rewards. For example, the rewards may be based on transaction fees from merchants and/or other receiving parties of a digital asset-based interaction.

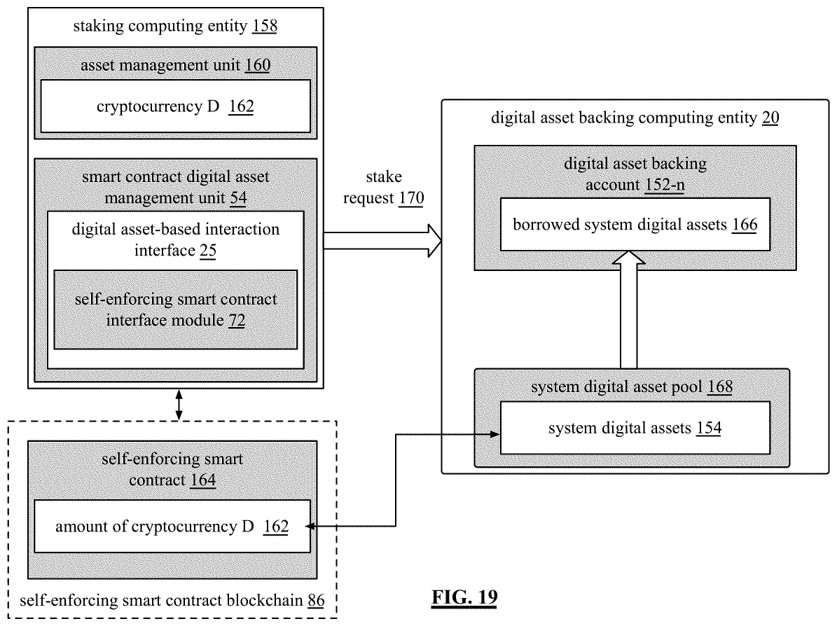

FIG. 19 is a schematic block diagram of an embodiment of a staking computing entity 158 interacting with a digital asset backing computing entity 20. The staking computing entity 158 includes an asset management unit 160 storing a cryptocurrency D 162 and a smart contract digital asset management unit 54. The smart contract digital asset management unit 54 includes a digital asset-based interaction interface 25. The digital asset-based interaction interface 25 interfaces with the digital asset backing computing entity 20 to facilitate backing digital asset-based interactions and interfaces with self-enforcing smart contract 52 to manage digital assets.

In this simplified example of the digital asset-based interaction interface 25, the digital asset-based interaction interface 25 includes access to a self-enforcing smart contract 52 via a self-enforcing smart contract interface module 72. The self-enforcing smart contract is hosted on a self-enforcing smart contract blockchain 86 (e.g., Ethereum).

In this example, the staking computing entity 158 has deposited an amount of cryptocurrency D into the self-enforcing smart contract 164 and sent a stake request 170 to the digital asset backing computing entity 170. The self-enforcing smart contract 164 consists of pre-existing code in accordance with the digital asset-based interaction system to control deposits to, withdrawals from, and transfers from the self-enforcing smart contract 164. Data inputs to the self-enforcing smart contract 164 may program new code based on a particular request to stake or new digital asset-based interaction.

The digital asset backing computing entity 20 includes a digital asset backing account 152-n that stores system digital assets 166 to back digital asset-based interactions as determined by the staking computing entity 158. The staking computing entity may have an existing account or the stake request 170 make create the digital asset backing account 152-n.

In this example, the staking computing entity 158 wishes to back digital asset-based interactions with an amount of cryptocurrency D 162. However, the digital asset backing computing entity 20 only backs digital asset-based interactions with system digital assets. As such, when the amount of cryptocurrency D 162 is deposited into the self-enforcing smart contract 164 and the stake request is received, the amount of cryptocurrency D 162 can be locked and used to borrow a substantially equivalent amount of system digital assets from a system digital asset pool 168 of the digital asset backing computing entity 20. The system digital asset pool 168 may include the stake pool as discussed in previous Figures and/or a pool of unstaked system digital assets. The borrowed system digital assets 166 are then deposited and/or associated with the digital asset backing account 152-n.

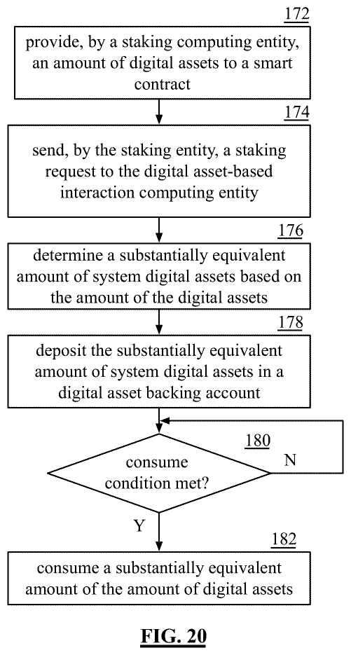

FIG. 20 is a flowchart of an example of a method of borrowing system digital assets to back digital asset-based interactions of a digital asset-based interaction system. The method begins with step 172 where a staking computing entity of the digital asset-based interaction system provides an amount of digital assets to a self-enforcing smart contract associated with a digital asset-based interaction computing entity of the digital asset-based interaction system.

The staking computing entity may be any computing entity such as a user computing device, a digital asset management computing entity, etc. that wishes to back digital asset-based interactions of the digital asset-based interaction system. The method continues with step 174 where the staking computing entity sends a stake request to the digital asset-based interaction computing entity. The stake request includes a request to stake the amount of the digital assets to back digital asset-based interactions of the digital asset-based interaction system. The method continues with step 176 where the digital asset-based interaction computing entity determines a substantially equivalent amount of system digital assets based on the amount of digital assets to produce an amount of borrowed system digital assets. The amount of borrowed system digital assets are obtained from the stake pool and/or a pool of unstaked system digital assets.

The method continues with step 178 where the digital asset-based interaction computing entity associates the amount of borrowed system digital assets with a digital asset backing account associated with the staking computing entity. The amount of digital assets are locked within the self-enforcing smart contract such that the staking computing entity is unable to transfer or withdraw the amount of digital assets until certain conditions are met (e.g., a request to withdraw and/or un-stake is provided and the amount of borrowed system digital assets are not locked for a digital asset-based interaction).

When a consume condition associated with a locked portion of the borrowed system digital assets is met at step 180, the method continues with step 182 where the digital asset-based interaction computing entity consumes a substantially equivalent amount of the amount of digital assets based on the locked portion of the substantially equivalent amount of system digital assets to cover the locked portion of the borrowed system digital assets within the digital asset-based interaction system. The consume condition is a condition that triggers the digital asset-based interaction computing entity to consumes system digital assets to cover an interaction. However, in this case, the digital asset-based interaction computing entity consumes a substantially equivalent amount of the amount of digital assets.

For example, a consume condition occurs when the digital asset-based interaction computing entity does not verify (e.g., using a verification process) an amount of the digital asset received by the first computing entity of a digital asset-based interaction. For example, if fraudulent activity occurs (e.g., the first computing entity acts maliciously to spend at two merchants simultaneously, software of the asset management unit is corrupted, etc.) the digital asset-based interaction computing entity consumes the amount of system digital asset associated with the real-time digital asset interaction. As a specific example, if the first computing entity attempts to double spend a transaction, the verification (e.g., the desired number of confirmations in a Bitcoin blockchain example) will not be received and the digital asset-based interaction computing entity will not be able to verify the amount of the digital asset received by the first computing entity.

If the verification is not received, the digital asset-based interaction computing entity withdraws (e.g., consumes) the substantially equivalent amount of the amount of digital assets locked within the self-enforcing smart contract to cover the digital asset-based interaction that occurred with a second computing entity. Consuming the substantially equivalent amount of the amount of digital assets means that the amount of the substantially equivalent amount of the amount of digital assets is transferred (e.g., via an on-chain transaction) from an address associated with the staking computing entity to an address associated with the digital asset-based interaction computing entity.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computing entity of a digital asset-based interaction system, the computing entity comprises:
memory; and
a smart contract digital asset management unit including a digital asset-based interaction interface, wherein the digital asset-based interaction interface is associated with a digital asset-based interaction computing entity of the digital asset-based interaction system, and wherein the digital asset-based interaction interface is operable to:
interface with the digital asset-based interaction computing entity to execute one or more digital asset-based interactions between the computing entity and one or more other computing entities of the digital asset-based interaction system, wherein a digital asset-based interaction of the one or more the digital asset-based interactions includes a real-time digital asset-based interaction process and a nonreal-time digital asset-based interaction process, and wherein the computing entity uses a first digital asset and the one or more other computing entities accept assets in a desired asset format; and
interface with a self-enforcing smart contract associated with the computing entity and the digital asset-based interaction computing entity to manage one or more digital assets, wherein the one or more digital assets includes the first digital asset.

2. The computing entity of claim 1, wherein the digital asset-based interaction interface is operable to interface with the self-enforcing smart contract to manage the one or more digital assets by one or more of:
depositing the one or more digital assets to an account of the self-enforcing smart contract, wherein the account is associated with the computing entity;
withdrawing at least a portion of the one or more digital assets from the account of the self-enforcing smart contract;
transferring the one or more digital assets to an address associated with the digital asset-based interaction computing entity, wherein the digital asset-based interaction computing entity is operable to deposit the one or more digital assets to the account of the self-enforcing smart contract; and
sending a request to withdrawal the at least the portion of the one or more digital assets to the digital asset-based interaction computing entity, wherein the digital asset-based interaction computing entity is operable to withdraw the one or more digital assets from the account of the self-enforcing smart contract on behalf of the computing entity.

3. The computing entity of claim 2, wherein the digital asset-based interaction interface is operable to interface with the self-enforcing smart contract to deposit the one or more digital assets by one or more of:
depositing the one or more digital assets to store the one or more digital assets in the account of the self-enforcing smart contract; and
depositing the first digital asset in the account of the self-enforcing smart contract for the digital asset-based interaction.

4. The computing entity of claim 1, wherein the digital asset-based interaction interface is operable to interface with the digital asset-based interaction computing entity to execute the real-time digital asset-based interaction process by:
exchanging an amount of the first digital asset for a substantially equivalent amount of the assets in the desired asset format; and
providing the substantially equivalent amount of the assets in the desired asset format to the one or more other computing entities.

5. The computing entity of claim 1, wherein the digital asset-based interaction interface is operable to interface with the digital asset-based interaction computing entity to execute the nonreal-time digital asset-based interaction process by:
locking an amount of system digital assets to back the digital asset-based interaction, wherein one or more staking computing entities provide system digital assets to the digital asset-based interaction computing entity to back the digital asset-based interactions;
implementing a nonreal-time verification process associated with the first digital asset to verify the amount of the first digital asset;
when the amount of first digital asset obtained from the computing entity is verified by the nonreal-time verification process:
unlocking the amount of system digital assets; and
when the amount of first digital asset obtained from the computing entity is not verified by the nonreal-time verification process:
consuming the amount of system digital assets.

6. The computing entity of claim 1, wherein the digital asset-based interaction interface is operable to:
provide one or more data inputs to the self-enforcing smart contract to indicate one or more of:
the initiation of the digital asset-based interaction;
information pertaining to the digital asset-based interaction; and
a computing entity request regarding management of the one or more digital assets.

7. The computing entity of claim 6, wherein the information pertaining to the digital asset-based interaction includes one or more of:
an amount of the digital asset-based interaction;
an item involved in the digital asset-based interaction;
the type of the first digital asset;
the type of the one or more other digital assets;
an identifier of the computing entity; and
an identifier of the one or more other computing entities.

8. The computing entity of claim 1 further comprises:
a display; and
one or more scanning devices.

9. The computing entity of claim 8, wherein the smart contract digital asset management unit further comprises:
a scanning interface coupled to the one or more scanning devices.

10. A digital asset-based interaction system comprises:
a digital asset-based interaction computing entity operable to facilitate one or more digital asset-based interactions between a first computing entity and one or more other computing entities of the digital asset-based interaction system, wherein a digital asset-based interaction of the one or more the digital asset-based interactions includes a real-time digital asset-based interaction process and a nonreal-time digital asset-based interaction process, and wherein the first computing entity uses a first digital asset and the one or more other computing entities accept assets in a desired asset format;
one or more staking computing entities operable to back the one or more digital asset-based interactions with system digital assets; and
a first computing entity including a smart contract digital asset management unit including a digital asset-based interaction interface, wherein the digital asset-based interaction interface is associated with the digital asset-based interaction computing entity, and wherein the digital asset-based interaction interface is operable to:
interface with the digital asset-based interaction computing entity to execute the one or more digital asset-based interactions; and
interface with a self-enforcing smart contract associated with the first computing entity and the digital asset-based interaction computing entity to manage one or more digital assets, wherein the one or more digital assets includes the first digital asset.

11. The digital asset-based interaction system of claim 10, wherein the digital asset-based interaction interface is operable to interface with the self-enforcing smart contract to manage the one or more digital assets by one or more of:
depositing the one or more digital assets to an account of the self-enforcing smart contract, wherein the account is associated with the first computing entity;
withdrawing at least a portion of the one or more digital assets from the account of the self-enforcing smart contract;
transferring the one or more digital assets to an address associated with the digital asset-based interaction computing entity, wherein the digital asset-based interaction computing entity is operable to deposit the one or more digital assets to the account of the self-enforcing smart contract; and
sending a request to withdrawal the at least the portion of the one or more digital assets to the digital asset-based interaction computing entity, wherein the digital asset-based interaction computing entity is operable to withdraw the one or more digital assets from the account of the self-enforcing smart contract on behalf of the first computing entity.

12. The digital asset-based interaction system of claim 11, wherein the digital asset-based interaction interface is operable to interface with the self-enforcing smart contract to deposit the one or more digital assets by one or more of:
depositing the one or more digital assets to store the one or more digital assets in the account of the self-enforcing smart contract; and
depositing the first digital asset in the account of the self-enforcing smart contract for the digital asset-based interaction.

13. The digital asset-based interaction system of claim 10, wherein the digital asset-based interaction computing entity is operable to execute the real-time digital asset-based interaction process by:
exchanging an amount of the first digital asset for a substantially equivalent amount of the assets in the desired asset format; and
providing the substantially equivalent amount of the assets in the desired asset format to the one or more other computing entities.

14. The digital asset-based interaction system of claim 10, wherein the digital asset-based interaction computing entity is operable to execute the nonreal-time digital asset-based interaction process by:
locking an amount of the system digital assets to back the digital asset-based interaction, wherein the one or more staking computing entities provided the amount of the system digital to back the digital asset-based interaction;
implementing a nonreal-time verification process associated with the first digital asset to verify the amount of the first digital asset;
when the amount of first digital asset obtained from the computing entity is verified by the nonreal-time verification process:
unlocking the amount of system digital assets; and
when the amount of first digital asset obtained from the first computing entity is not verified by the nonreal-time verification process:
consuming the amount of system digital assets.

15. The digital asset-based interaction system of claim 10, wherein on or more of the digital asset-based interaction computing entity and the digital asset-based interaction interface is operable to:
provide one or more data inputs to the self-enforcing smart contract to indicate one or more of:
the initiation of the digital asset-based interaction;
information pertaining to the digital asset-based interaction; and
a request regarding management of the one or more digital assets.

16. The digital asset-based interaction system of claim 15, wherein the information pertaining to the digital asset-based interaction includes one or more of:
an amount of the digital asset-based interaction;
an item involved in the digital asset-based interaction;
the type of the first digital asset;
the type of the one or more other digital assets;
an identifier of the computing entity; and
an identifier of the one or more other computing entities.

17. The digital asset-based interaction system of claim 10, wherein the first computing entity further comprises:
a display; and
one or more scanning devices.

18. The digital asset-based interaction system of claim 17, wherein the smart contract digital asset management unit further comprises:
a scanning interface coupled to the one or more scanning devices.
